(19) United States
(12) Patent Application Publication
(10) Pub. No.: US 2026/0054271 A1
(43) Pub. Date: Feb. 26, 2026

(54) ELECTRICAL DUST COLLECTOR, METHOD OF CONTROLLING THE SAME, AND AIR HANDLER INCLUDING THE ELECTRICAL DUST COLLECTOR

(71) Applicant: SAMSUNG ELECTRONICS CO., LTD., Suwon-si (KR)

(72) Inventors: Sangmo KANG, Suwon-si (KR); Myungsoo KANG, Suwon-si (KR); Hyongsoo NOH, Suwon-si (KR); Myungseob SONG, Suwon-si (KR); Joonoh SHIN, Suwon-si (KR)

(73) Assignee: SAMSUNG ELECTRONICS CO., LTD., Suwon-si (KR)

(21) Appl. No.: 19/195,076

(22) Filed: Apr. 30, 2025

Related U.S. Application Data
(63) Continuation of application No. PCT/KR2025/004875, filed on Apr. 10, 2025.

(30) Foreign Application Priority Data
Aug. 21, 2024 (KR) 10-2024-0112349

(51) Int. Cl. B03C 3/68; B03C 3/45

(52) U.S. Cl. CPC B03C 3/68; B03C 3/45

(57) ABSTRACT

Provided are an air handler, an electrical dust collector, and a method of controlling same. The electrical dust collector includes: a charger for charging a substance in air; a dust collector configured to remove the substance from the air, the dust collector including: a first conductive layer including pattern electrodes, and a second conductive layer adjacent to the first conductive layer; memory storing instructions; and a processor configured to execute the instructions to: apply, to the first conductive layer, a voltage with the same polarity as the substance, the voltage being an AC or a PWM voltage; based on the voltage being the AC voltage, apply to the second conductive layer a voltage used when collecting the substance or a reference AC voltage; and based on the voltage being the PWM voltage, apply to the second conductive layer the voltage used when collecting the substance or a reference PWM voltage.

### CROSS-REFERENCE TO RELATED APPLICATIONS

This application is a by-pass continuation of International Application No. PCT/KR2025/004875, filed on Apr. 10, 2025, which is based on and claims priority to Korean Patent Application No. 10-2024-0112349, filed in the Korean Intellectual Property Office on Aug. 21, 2024, the disclosures of which are incorporated by reference herein in their entireties.

### BACKGROUND

### 1. Field

The disclosure relates to an electrical dust collector, a method of controlling the same, and an air handler including the electrical dust collector. More particularly, the disclosure relates to a technology for collecting and removing a foreign substance in the air.

### 2. Description of Related Art

An electrical dust collector may be a device that removes foreign substances in the air by charging and collecting the foreign substances. Electrical dust collectors have been widely used in power plants, cement production, and steel industries to reduce air pollution. The electrical dust collector may be installed in an air purifier or an air conditioner with an air purification function, which is installed inside a building or a vehicle, to improve air quality. The electrical dust collector may include a charger and a dust collector.

The charger may charge a foreign substance in the air. The charger may charge particles in the air by using a variety of technologies, including corona discharge, dielectric barrier discharge, field charging, and diffusion charging by using a high-voltage electric field. The dust collector may remove the charged foreign substance. The dust collector may form an electric field. The dust collector may collect the charged foreign substance by using an electric field with an electrode such as a dust collector plate provided in the charger.

However, in the case of an electrical dust collector according to the related art, an electric field of the charger decreases as more charged foreign substances are collected in the charger. As a result, the energy efficiency of the electrical dust collector decreases. In addition, when charged foreign substances are collected in the charger and excessive charges are accumulated in the charger, a back corona phenomenon occurs in which charges are released into the air from the charger. As a result, the electrical dust collector may be damaged.

### SUMMARY

According to an aspect of the disclosure, an electrical dust collector includes: a charger configured to charge a foreign substance in air; a dust collector configured to collect the charged foreign substance and to remove the charged foreign substance from the air, the dust collector including: a first conductive layer including a plurality of pattern electrodes; and a second conductive layer adjacent to the first conductive layer; memory storing one or more instructions; and at least one processor, wherein the one or more instructions, when executed by the at least one processor individually or collectively, cause the electrical dust collector to: apply, to the first conductive layer, a voltage with a same polarity as the charged foreign substance, wherein the voltage includes at least one of an alternating current (AC) voltage or a pulse width modulation (PWM) voltage, based on the voltage being the AC voltage, apply to the second conductive layer a voltage used when collecting the charged foreign substance or a reference AC voltage, and based on the voltage being the PWM voltage, apply to the second conductive layer the voltage used when collecting the charged foreign substance or a reference PWM voltage.

The plurality of pattern electrodes may be respective lines spaced at regular intervals.

Each of the plurality of pattern electrodes may be in a spiral shape or a zigzag shape on the first conductive layer.

An interval between the plurality of pattern electrodes may be less than or equal to a distance between the first conductive layer and the second conductive layer.

A strength of an electric field formed between the plurality of pattern electrodes may be 3 kV/mm or less.

A waveform of the voltage may include at least one of a sine shape, a square shape, or a ramp shape.

A phase difference value of the voltage may include a quotient of a period of the voltage and a number of phases of the voltage.

A frequency of the voltage may be greater than or equal to 5 Hz and less than or equal to 200 Hz.

According to an aspect of the disclosure, a method of controlling an electrical dust collector includes: applying, to a first conductive layer of the electrical dust collector, a voltage with a same polarity as a charged foreign substance, wherein the first conductive layer includes a plurality of pattern electrodes, and wherein the voltage includes at least one of an alternative current (AC) voltage or a pulse width modulation (PWM) voltage; based on the voltage being the AC voltage, applying to a second conductive layer of the electrical dust collector a voltage used when collecting the charged foreign substance or a reference AC voltage, wherein the second conductive layer is adjacent to the first conductive layer; and based on the voltage being the PWM voltage, applying to the second conductive layer the voltage used when collecting the charged foreign substance or a reference PWM voltage.

The plurality of pattern electrodes may be respective lines spaced at regular intervals.

Each of the plurality of pattern electrodes may be in a spiral shape or a zigzag shape on the first conductive layer.

An interval between the plurality of pattern electrodes may be less than or equal to a distance between the first conductive layer and the second conductive layer.

A strength of an electric field formed between the plurality of pattern electrodes may be 3 kV/mm or less.

A waveform of the voltage may include at least one of a sine shape, a square shape, or a ramp shape.

A phase difference value of the voltage may include a quotient of a period of the voltage and a number of phases of the voltage.

According to an aspect of the disclosure, a dust collector includes: a first conductive layer including a plurality of pattern electrodes; a second conductive layer adjacent to the first conductive layer; memory storing one or more instructions; and at least one processor, wherein the one or more instructions, when executed by the at least one processor individually or collectively, cause the dust collector to: apply, to the first conductive layer, a voltage with a same polarity as a charged foreign substance in air, wherein the voltage is at least one of an alternating current (AC) voltage or a pulse width modulation (PWM) voltage, based on the voltage being the AC voltage, apply to the second conductive layer a voltage used when collecting the charged foreign substance or a reference AC voltage, and based on the voltage being the PWM voltage, apply to the second conductive layer the voltage used when collecting the charged foreign substance or a reference PWM voltage.

The plurality of pattern electrodes may be respective lines spaced at regular intervals.

Each of the plurality of pattern electrodes may be in a spiral shape or a zigzag shape on the first conductive layer.

An interval between the plurality of pattern electrodes may be less than or equal to a distance between the first conductive layer and the second conductive layer.

A strength of an electric field formed between the plurality of pattern electrodes may be 3 kV/mm or less.

According to an aspect of the disclosure, an electrical dust collector includes: a charger configured to charge a foreign substance in air; a dust collector including: a first conductive layer including a plurality of pattern electrodes; and a second conductive layer adjacent to the first conductive layer; memory storing one or more instructions; and at least one processor configured to individually or collectively execute the one or more instructions, wherein the one or more instructions, when executed by the at least one processor individually or collectively, cause the electrical dust collector to: collect the charged foreign substance from the air by applying a first direct current (DC) voltage to the first conductive layer and applying a second DC voltage to the second conductive layer, wherein the second DC voltage includes a ground DC voltage or a reference DC voltage; and remove the collected charged foreign substance from the dust collector by: applying, to the first conductive layer, a voltage with a same polarity as the collected charged foreign substance, wherein the voltage includes at least one of an alternating current (AC) voltage or a pulse width modulation (PWM) voltage, based on the voltage being the AC voltage, applying to the second conductive layer the second DC voltage or a reference AC voltage, and based on the voltage being the PWM voltage, applying to the second conductive layer the second DC voltage or a reference PWM voltage.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram showing an air handler according to one or more embodiments of the disclosure;

FIG. 2 is a diagram showing a case in which an electrical dust collector provided in an air handler removes foreign substances accumulated in a dust collector, according to one or more embodiments of the disclosure;

FIG. 3 is a block diagram showing a dust collector of an electrical dust collector according to one or more embodiments of the disclosure;

FIG. 4 is a diagram showing a first conductive layer of a dust collector according to one or more embodiments of the disclosure;

FIG. 5 is a diagram showing a first conductive layer of a dust collector according to one or more embodiments of the disclosure;

FIG. 6 is a diagram showing a first conductive layer of a dust collector according to one or more embodiments of the disclosure;

FIG. 7 is a diagram showing a first conductive layer of a dust collector according to one or more embodiments of the disclosure;

FIG. 8 is a diagram showing a first conductive layer of a dust collector according to one or more embodiments of the disclosure;

FIG. 9 is a diagram showing a second conductive layer of a dust collector according to one or more embodiments of the disclosure;

FIG. 10 is a graph showing a voltage applied to a first conductive layer of a dust collector according to one or more embodiments of the disclosure;

FIG. 11 is a graph showing a voltage applied to a second conductive layer of a dust collector according to one or more embodiments of the disclosure;

FIG. 12 is a graph showing a voltage applied to a first conductive layer of a dust collector according to one or more embodiments of the disclosure;

FIG. 13 is a graph showing a voltage applied to a second conductive layer of a dust collector according to one or more embodiments of the disclosure;

FIG. 14 is a graph showing a voltage applied to a first conductive layer of a dust collector according to one or more embodiments of the disclosure;

FIG. 15 is a graph showing a voltage applied to a second conductive layer of a dust collector according to one or more embodiments of the disclosure;

FIG. 16 is a graph showing a voltage applied to a first conductive layer of a dust collector according to one or more embodiments of the disclosure;

FIG. 17 is a graph showing a 2-phase voltage applied to a first conductive layer of a dust collector according to one or more embodiments of the disclosure;

FIG. 18 is a graph showing a 3-phase voltage applied to a first conductive layer of a dust collector according to one or more embodiments of the disclosure;

FIG. 19 is a diagram showing a case in which a foreign substance is moved by applying a voltage to a first conductive layer of a dust collector according to one or more embodiments of the disclosure;

FIG. 20 is a diagram showing a case in which a foreign substance is moved by applying a voltage to a first conductive layer of a dust collector according to one or more embodiments of the disclosure;

FIG. 21 is a diagram showing an electrodynamic force applied to a foreign substance by an electrical dust collector according to one or more embodiments of the disclosure;

FIG. 22 is a diagram showing an electrodynamic force applied to a foreign substance by an electrical dust collector according to one or more embodiments of the disclosure;

FIG. 23 is a diagram showing an electrodynamic force applied to a foreign substance by an electrical dust collector according to one or more embodiments of the disclosure;

FIG. 24 is a diagram showing movement of a foreign substance based on a 3-phase voltage applied to a first conductive layer by an electrical dust collector according to one or more embodiments of the disclosure;

FIG. 25 is a graph showing an electric field based on a phase difference of a voltage applied to a first conductive layer by an electrical dust collector according to one or more embodiments of the disclosure;

FIG. 26 is a diagram showing an amount of impact based on a phase difference of a voltage applied to a first conductive layer by an electrical dust collector according to one or more embodiments of the disclosure;

FIG. 27 is a diagram showing an amount of impact based on a phase difference of a voltage applied to a first conductive layer by an electrical dust collector according to one or more embodiments of the disclosure;

FIG. 28 is a diagram showing an amount of impact based on a waveform of a voltage applied to a first conductive layer by an electrical dust collector according to one or more embodiments of the disclosure;

FIG. 29 is a diagram showing an amount of impact based on a waveform of a voltage applied to a first conductive layer by an electrical dust collector according to one or more embodiments of the disclosure; and

FIG. 30 is a diagram showing an amount of impact based on a frequency of a voltage applied to a first conductive layer by an electrical dust collector according to one or more embodiments of the disclosure.

### DETAILED DESCRIPTION

The various embodiments and terms used herein are not intended to limit the technical features of the disclosure to specific embodiments, but rather to encompass various modifications, equivalents, or alternatives of the various embodiments.

With regard to a description of drawings, similar reference numerals may be used for similar or related components.

The singular form of a noun corresponding to an item may include one or more of the items, unless the context clearly indicates otherwise.

In this document, each of the phrases “A or B”, “at least one of A and B”, “at least one of A or B”, “A, B, or C”, “at least one of A, B, and C”, and “at least one of A, B, or C” may include any one of the items listed together in the phrase, or all possible combinations thereof.

The term “and/or” includes any combination of a plurality of related described components or any one of the plurality of related described components.

The terms such as “1st”, “2nd”, or “first” or “second” may be used merely to distinguish one component from another, and do not limit the components in any other aspect (e.g., importance or order).

When a component (e.g., a first component) is referred to as being “coupled” or “connected” to another component (e.g., a second component), with or without the terms “functionally” or “communicatively,” it means that the component may be connected to the other component directly (e.g., wired), wirelessly, or through a third component.

The terms “include” or “have” are intended to specify the presence of a feature, number, step, operation, component, part, or combination thereof described in this document, but do not exclude the presence or addition of one or more other features, numbers, steps, operations, components, parts, or combinations thereof.

When a component is said to be “connected,” “coupled,” “supported,” or “in contact with” another component, this includes not only a case in which the components are directly connected, coupled, supported, or in contact, but also a case in which the components are indirectly connected, coupled, supported, or in contact through a third component.

When a component is said to be “on” another component, this includes not only a case in which the component is in contact with the other component, but also a case in which there is another component between the two components.

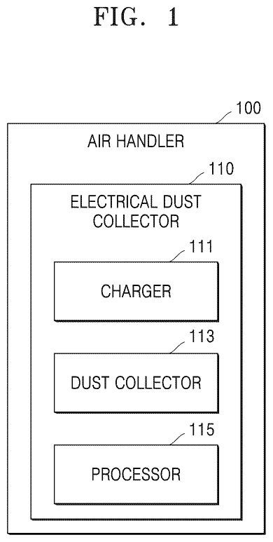

FIG. 1 is a block diagram showing an air handler 100 according to one or more embodiments.

The air handler 100 according to one or more embodiments of the disclosure is a device that performs functions such as air purification, ventilation, humidity control, cooling or heating in an air-conditioned space (hereinafter referred to as “indoor”), and means a device including at least one of these functions. For example, the air handler 100 may include an air conditioner or an air purifier.

According to one or more embodiments of the disclosure, the air handler 100 may include a heat pump device to perform a cooling function or a heating function. The heat pump device may include a refrigeration cycle in which a refrigerant is circulated along a compressor, a first heat exchanger, an expansion device, and a second heat exchanger. All components of the heat pump device may be built into a single housing defining an outer appearance of the air handler 100, and a window-type air conditioner or a portable air conditioner corresponds to the air handler 100. According to another aspect, some components of the heat pump device may be divided and built into a plurality of housings defining a single air handler 100, including a wall-mounted air conditioner, a stand-alone air conditioner, and a system air conditioner.

The air handler 100 including a plurality of housings may include at least one outdoor unit installed outdoors and at least one indoor unit installed indoors. For example, the air handler 100 may be provided such that one outdoor unit and one indoor unit are connected through a refrigerant pipe. For example, the air handler 100 may be provided such that one outdoor unit is connected to two or more indoor units through a refrigerant pipe. For example, the air handler 100 may be provided such that two or more outdoor units and two or more indoor units are connected through a plurality of refrigerant pipes.

The outdoor unit may be electrically connected to the indoor unit. For example, information (or command) for controlling an air handler may be input through an input interface provided on the outdoor unit or the indoor unit, and the outdoor unit and the indoor unit may operate simultaneously or sequentially in response to a user input.

The air handler 100 may include an outdoor heat exchanger provided in the outdoor unit, an indoor heat exchanger provided in the indoor unit, and a refrigerant pipe connecting the outdoor heat exchanger and the indoor heat exchanger.

The outdoor heat exchanger may perform heat exchange between a refrigerant and outdoor air by using a phase change of the refrigerant (e.g., evaporation or condensation). For example, while the refrigerant condenses in the outdoor heat exchanger, the refrigerant may release heat to the outdoor air, and while the refrigerant flowing in the outdoor heat exchanger evaporates, the refrigerant may absorb heat from the outdoor air.

The indoor unit is installed indoors. For example, the indoor unit may be classified into a ceiling-mounted indoor unit, a stand-alone indoor unit, and a wall-mounted indoor unit depending on a method of placing the indoor unit. For example, the ceiling-mounted indoor unit may be classified into a 4-way indoor unit, a 1-way indoor unit, a duct-type indoor unit, and the like, depending on a method of discharging air.

Similarly, the indoor heat exchanger may perform heat exchange between a refrigerant and indoor air by using a phase change of the refrigerant (e.g., evaporation or condensation). For example, while a refrigerant evaporates in the indoor unit, the refrigerant may absorb heat from the indoor air, and an indoor area may be cooled by blowing the indoor air that is cooled through the cooled indoor heat exchanger. While the refrigerant is condensed in the indoor heat exchanger, the refrigerant may release heat to the indoor air, and the indoor area may be heated by blowing the indoor air that is heated through the high-temperature indoor heat exchanger.

That is, the air handler 100 may perform a cooling or heating function through a phase change process of the refrigerant circulating through the outdoor heat exchanger and the indoor heat exchanger, and for this circulation of the refrigerant, the air handler 100 may include a compressor that compresses the refrigerant. The compressor may suck in refrigerant gas through a suction portion and compress the refrigerant gas. The compressor may discharge high-temperature and high-pressure refrigerant gas through a discharge port. The compressor may be placed inside the outdoor unit.

The refrigerant may be circulated through the refrigerant pipes in the order of a compressor, an outdoor heat exchanger, an expansion device, and an indoor heat exchanger, or in the order of the compressor, the indoor heat exchanger, the expansion device, and the outdoor heat exchanger.

For example, in the air handler 100, when one outdoor unit is directly connected to one indoor unit through a refrigerant pipe, the refrigerant may be provided to be circulated between one outdoor unit and one indoor unit through the refrigerant pipe.

For example, in the air handler 100, when one outdoor unit is connected to two or more indoor units through a refrigerant pipe, the refrigerant may flow to a plurality of indoor units through the refrigerant pipe branching from the outdoor unit. Refrigerants discharged from the plurality of indoor units may be combined with each other and circulated to the outdoor unit. For example, the plurality of indoor units may be directly connected in parallel to one outdoor unit through separate refrigerant pipes.

The plurality of indoor units may be operated independently according to an operating mode set by a user. That is, some of the plurality of indoor units may be operated in a cooling mode, and others may be operated in a heating mode at the same time. In this case, the refrigerant may be selectively introduced into each indoor unit at a high or low pressure along a designated circulation path through a flow path switching valve described below, and discharged to be circulated to the outdoor unit.

For example, in the air handler 100, when two or more outdoor units and two or more indoor units connected through a plurality of refrigerant pipes, refrigerants discharged from the plurality of outdoor units may be combined with each other, may flow through one refrigerant pipe, may be branched again at some points, and may flow into the plurality of indoor units.

The plurality of outdoor units may all be driven or at least some may not be driven depending on an operating load based on an operating amount of the plurality of indoor units. In this case, the refrigerant may be provided to be introduced into and circulated in the outdoor unit that is selectively driven through the flow path switching valve. The air handler may include an expansion device to reduce a pressure of the refrigerant introduced into a heat exchanger. For example, the expansion device may be placed inside the indoor unit or inside the outdoor unit, or may be placed in both the indoor unit and the outdoor unit.

The expansion device may lower the temperature and pressure of the refrigerant using, for example, a throttling effect. The expansion device may include an orifice for reducing a cross-sectional area of a flow path. The temperature and pressure of a refrigerant passing through the orifice may be lowered.

The expansion device may be implemented as an electronic expansion valve, for example, for controlling an opening ratio (a ratio of a cross-sectional area of a flow path of a valve in a partially open state to a cross-sectional area of a flow path of the valve in a fully open state). The amount of refrigerant passing through the expansion device may be controlled depending on the opening ratio of the electronic expansion valve.

The air handler 100 may further include a flow path switching valve disposed on a refrigerant circulation flow path. The flow path switching valve may include, for example, a 4-way valve. The flow path switching valve may determine a circulation path of the refrigerant depending on an operating mode of the indoor unit (e.g., cooling operation or heating operation). The flow path switching valve may be connected to the discharge port of the compressor.

The air handler 100 may include an accumulator. The accumulator may be connected to the suction portion of the compressor. The accumulator may receive a low-temperature and low-pressure refrigerant evaporated from the indoor heat exchanger or the outdoor heat exchanger.

The accumulator may separate a refrigerant liquid from the refrigerant gas when the refrigerant, which is a mixture of the refrigerant liquid and the refrigerant gas, is introduced, and provide, to the compressor, the refrigerant gas from which the refrigerant liquid is separated.

An outdoor fan may be provided adjacent to the outdoor heat exchanger. The outdoor fan may blow outdoor air to the outdoor heat exchanger to promote heat exchange between the refrigerant and the outdoor air.

The outdoor unit of the air handler 100 may include at least one sensor. For example, the sensor of the outdoor unit may be provided as an environment sensor. The outdoor unit sensor may be placed at any location inside or outside the outdoor unit. For example, the outdoor unit sensor may include a temperature sensor for detecting an air temperature around the outdoor unit, a humidity sensor for detecting an air humidity around the outdoor unit, a refrigerant temperature sensor for detecting a refrigerant temperature in a refrigerant pipe passing through the outdoor unit, or a refrigerant pressure sensor for detecting a refrigerant pressure in a refrigerant pipe passing through the outdoor unit.

The outdoor unit of the air handler 100 may include a communication unit of the outdoor unit. The communication unit of the outdoor unit may be provided to receive a control signal from a controller of the indoor unit of the air handler, which is to be described below. The outdoor unit may control an operation of the compressor, the outdoor heat exchanger, the expansion device, the flow path switching valve, the accumulator, or the outdoor fan based on the control signal received through the communication unit of the outdoor unit. The outdoor unit may transmit a sensing value detected from the outdoor unit sensor to the controller of the indoor unit through the communication unit of the outdoor unit.

The indoor unit of the air handler 100 may include a housing, a blower that circulates air inside or outside the housing, and an indoor heat exchanger that exchanges heat with air flowing into the housing.

The housing may include a suction port. Through the suction port, indoor air may be introduced into the housing.

The indoor unit of the air handler 100 may include a filter provided to filter a foreign substance in the air flowing into the housing through the suction port.

The housing may include a discharge port. Air flowing inside the housing may be discharged to the outside of the housing through the discharge port.

The housing of the indoor unit may be provided with an airflow guide that guides a direction of air discharged through the discharge port. For example, the airflow guide may include a blade positioned on the discharge port. For example, the airflow guide may include an auxiliary fan to adjust a discharged airflow. Without being limited thereto, the airflow guide may be omitted.

An indoor heat exchanger and a blower that are placed on a flow path connecting the suction port and the discharge port may be provided inside the housing of the indoor unit.

The blower may include an indoor fan and a fan motor. For example, the indoor fan may include an axial fan, a mixed flow fan, a crossflow fan, and a centrifugal fan.

The indoor heat exchanger may be placed between the blower and the discharge port, or between the suction port and the blower. The indoor heat exchanger may absorb heat from air introduced through the suction port or transfer heat to the air introduced through the suction port. The indoor heat exchanger may include a heat exchange pipe through which a refrigerant flows, and a heat exchange fin in contact with the heat exchange pipe to increase a heating surface area.

The indoor unit of the air handler may include a drain tray disposed below the indoor heat exchanger to collect a condensate generated in the indoor heat exchanger. The condensate collected in the drain tray may be drained to the outside through a drain hose. The drain tray may be provided to support the indoor heat exchanger.

The indoor unit of the air handler 100 may include an input interface. The input interface may include any type of user input device including a button, a switch, a touch screen, and/or a touch pad. The user may directly input setting data (e.g., desired indoor temperature, operation mode setting for cooling/heating/dehumidification/air purification, outlet selection setting, and/or wind speed setting) through the input interface.

The input interface may also be connected to an external input device. For example, the input interface may be electrically connected to a wired remote controller. The wired remote controller may be installed at a certain location in an indoor space (e.g., a section of a wall). The user may input setting data about an operation of the air handler by manipulating the wired remote controller. An electrical signal corresponding to the setting data obtained through the wired remote controller may be transmitted to the input interface. The input interface may include an infrared sensor. The user may remotely input the setting data about the operation of the air handler by using a wireless remote controller. The setting data input through the wireless remote controller may be transmitted to the input interface as an infrared signal.

The input interface may include a microphone. A voice command of the user may be obtained through the microphone. The microphone may convert the voice command of the user into an electrical signal and transmit the converted electrical signal to the controller of the indoor unit. The controller of the indoor unit may control components of the air handler to execute a function corresponding to the voice command of the user. The setting data obtained through the input interface (e.g., desired indoor temperature, operation mode setting for cooling/heating/dehumidification/air purification, outlet selection setting, and/or wind speed setting) may be transferred to the controller of the indoor unit described below. In one example, the setting data obtained through the input interface may be transmitted externally, i.e. to the outdoor unit or a server, through the communication unit of the indoor unit, described below.

The indoor unit of the air handler 100 may include a power module. The power module may be connected to an external power supply to supply power to components of the indoor unit.

The indoor unit of the air handler 100 may include an indoor unit sensor. The indoor unit sensor may be an environment sensor placed in a space inside or outside the housing. For example, the indoor unit sensor may include one or more temperature sensors and/or humidity sensors placed in a predefined space inside or outside the housing of the indoor unit. For example, the indoor unit sensor may include a refrigerant temperature sensor for detecting a temperature of the refrigerant in the refrigerant pipe passing through the indoor unit. For example, the indoor unit sensor may include respective refrigerant temperature sensors that detect inlet, middle, and/or outlet temperatures of the refrigerant pipe passing through the indoor heat exchanger.

For example, environmental information detected by the indoor unit sensor may be transferred to the controller of the indoor unit, described below, or transmitted externally through the communication unit of the indoor unit, described below.

The indoor unit of the air handler 100 may include the communication unit of the indoor unit. The communication unit of the indoor unit may include at least one of a short-range wireless communication module or a long-range wireless communication module. The communication unit of the indoor unit may include at least one antenna for wirelessly communicating with other devices. The outdoor unit may include the communication unit of the outdoor unit. The communication unit of the outdoor unit may also include at least one of a short-range wireless communication module or a long-range wireless communication module.

The short-range wireless communication module may include, but is not limited to, a Bluetooth communication module, a Bluetooth low energy (BLE) communication module, a near field communication module, a WLAN (Wi-Fi) communication module, a Zigbee communication module, an infrared data association (IrDA) communication module, a Wi-Fi direct (WFD) communication module, an ultrawideband (UWB) communication module, an Ant+ communication module, and a microwave (uWave) communication module.

The long-range wireless communication module may include a communication module that performs various types of long-range communication and may include a mobile communication unit. The mobile communication unit transmits and receives a radio signal with at least one of a base station, an external terminal, or a server in a mobile communication network.

The communication unit of the indoor unit may communicate with an external device such as a server, a mobile device, and other home appliances through a surrounding access point (AP). The AP may connect a local area network (LAN), to which an air handler or a user device is connected, to a wide area network (WAN) in which a server is connected. The air handler or the user device may be connected to the server through the WAN. The indoor unit of the air handler may include the controller of the indoor unit, which controls components of the indoor unit, including a blower. The outdoor unit of the air handler may include the controller of the outdoor unit, which controls components of the outdoor unit, including a compressor. The controller of the indoor unit may communicate with the controller of the outdoor unit through the communication unit of the indoor unit and the communication unit of the outdoor unit. The communication unit of the outdoor unit may transmit a control signal generated by the controller of the outdoor unit to the communication unit of the indoor unit or may transfer a control signal transmitted from the communication unit of the indoor unit to the controller of the outdoor unit. That is, the outdoor unit and the indoor unit may communicate in both directions. The outdoor unit and the indoor unit may transmit and receive various signals generated during an operation of the air handler.

The controller of the outdoor unit may be electrically connected to components of the outdoor unit and control an operation of each component. For example, the controller of the outdoor unit may adjust a frequency of the compressor and control the flow path switching valve to switch a circulation direction of the refrigerant. The controller of the outdoor unit may control a rotation speed of the outdoor fan. The controller of the outdoor unit may generate a control signal to adjust an opening degree of an expansion valve. Under control of the controller of the outdoor unit, the refrigerant may be circulated along a refrigerant circulation flow path including a compressor, a flow path switching valve, an outdoor heat exchanger, an expansion valve, and an indoor heat exchanger.

Various temperature sensors provided in the outdoor unit and the indoor unit may transmit electrical signals corresponding to respective detected temperatures, to the controller of the outdoor unit and/or the controller of the indoor unit. For example, humidity sensors provided in the outdoor unit and the indoor unit may transmit electrical signals corresponding to respective detected humidity levels to the controller of the outdoor unit and/or the controller of the indoor unit.

The controller of the indoor unit may obtain a user input from a user device, including a mobile device, through the communication unit of the indoor unit and may obtain a user input directly through the input interface or through a remote controller. The controller of the indoor unit may control components of the indoor unit, including a blower, in response to a received user input. The controller of the indoor unit may transmit information about the received user input to the controller of the outdoor unit.

The controller of the outdoor unit may control components of the outdoor unit, including the compressor, based on information about the user input received from the indoor unit. For example, when receiving, from the indoor unit, a control signal corresponding to a user input for selecting an operating mode such as a cooling operation, a heating operation, a ventilation operation, a defrosting operation, or a dehumidifying operation, the controller of the outdoor unit may control the components of the outdoor unit such that the operation of the air handler corresponding to the selected operation mode is performed.

The controller of the outdoor unit and the controller of the indoor unit may each include a processor and a memory. The controller of the indoor unit may include at least one first processor and at least one first memory, and the controller of the outdoor unit may include at least one second processor and at least one second memory.

The memory may record/store various information necessary for an operation of the air handler. The memory may store an instruction, application, data, and/or program necessary for the operation of the air handler. For example, the memory may store various programs for the cooling operation, heating operation, dehumidifying operation and/or defrosting operation of the air handler. The memory may include volatile memory such as static random access memory (S-RAM) and dynamic random access memory (D-RAM) for temporarily storing data. The memory may include non-volatile memory such as read only memory (ROM), erasable programmable read only memory (EPROM), and electrically erasable programmable read only memory (EEPROM) for long-term storage of data.

The processor may generate a control signal for controlling an operation of the air handler based on an instruction, application, data and/or program stored in the memory. The processor may be hardware and may include a logic circuit and an arithmetic circuit. The processor may process data according to a program and/or instruction provided from the memory and generate a control signal according to the processing result. The memory and the processor may be implemented as a single control circuit or as a plurality of circuits.

The indoor unit of the air handler 100 may include an output interface. The output interface may be electrically connected to the controller of the indoor unit and may output information related to the operation of the air handler under control of the controller of the indoor unit. For example, information such as an operating mode, wind direction, wind speed, and temperature selected by a user input may be output. The output interface may output sensing information and warning/error messages obtained from the indoor unit sensor or the outdoor unit sensor.

The output interface may include a display and a speaker. The speaker may be an audio device and may output a variety of sounds. The display may display information input by the user or information provided to the user by using various graphic elements. For example, operation information of the air handler may be displayed as at least one of an image or a text. The display may include an indicator that provides certain information. The display may include a liquid crystal display (LCD) panel, a light emitting diode (LED) panel, an organic light emitting diode (OLED) panel, a micro LED panel, and/or a plurality of LEDs.

The air handler 100 may include an electrical dust collector 110. The electrical dust collector 110 may be a device that removes the foreign substance in the air by charging and collecting the foreign substance in the air. The electrical dust collector may be installed in an air purifier or an air conditioner with an air purification function, which is in turn installed inside a building or a vehicle to improve air quality. The electrical dust collector 110 may include a charger 111, a dust collector 113, and a processor 115. The dust collector 113 may have a structure separate from the charger 111. Accordingly, the electrical dust collector 110 may have a two-stage structure. The processor 115 may control the overall operation of the electrical dust collector 110.

The charger 111 may charge a foreign substance in the air. The foreign substance may be a particulate material floating in the air in the form of fine particles, such as dust. The charger 111 may electrically charge the foreign substance floating in the air. The charger 111 may charge particles in the air by using at least one of various methods such as corona discharge using a high voltage electric field, dielectric barrier discharge, electric field charging, and diffusion charging. For example, the charger 111 may accelerate electrons floating in the surrounding air in a corona discharge manner to apply a charge to an electrically neutral foreign substance.

The dust collector 113 may collect the charged foreign substance and remove the foreign substance from the air. The dust collector 113 may include a plurality of pattern electrodes. The dust collector 113 may attach the charged foreign substance to the plurality of pattern electrodes or a dust collector plate on which the plurality of pattern electrodes are mounted, by using an electric field. The dust collector 113 may collect the charged foreign substance by using the plurality of pattern electrodes or the dust collector plate to remove the foreign substance from the air.

The dust collector 113 may move the charged foreign substance along the plurality of pattern electrodes or the dust collector plate. The dust collector 113 may define an electric field to move the charged foreign substance between the plurality of pattern electrodes. The dust collector 113 may collect the charged foreign substance by the plurality of pattern electrodes or the dust collector plate by using the electric field.

As more charged foreign substances are collected in the charger 111 of the electrical dust collector 110, the electric field of the charger 111 may decrease. As a result, the energy efficiency of the electrical dust collector 110 may decrease. In addition, when charged foreign substances are collected in the charger 111 and excessive charges are accumulated in the charger 111, a back corona phenomenon may occur in which charges are released into the air from the charger 111. As a result, the electrical dust collector 110 may be damaged. The disclosure provides a method of removing foreign substances accumulated in the dust collector 113 of the electrical dust collector 110 to improve the energy efficiency of the electrical dust collector 110 and prevent damage to the electrical dust collector 110.

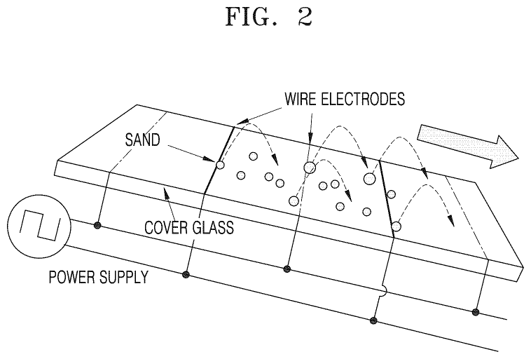

FIG. 2 is a diagram showing a scenario in which the electrical dust collector 110 provided in the air handler 100 removes foreign substances accumulated in the dust collector 113, according to one or more embodiments of the disclosure.

The electrical dust collector 110 may remove foreign substances accumulated in the dust collector 113 by using an electrodynamic method. The electrodynamic method may be a method of removing foreign substances accumulated on a surface of the dust collector 113 by generating an electrodynamic wave that separates the foreign substances accumulated on the surface of the dust collector 113 and then moves the foreign substances in one direction. The plurality of pattern electrodes built into the dust collector 113 may generate the electrodynamic wave. The foreign substances accumulated in the dust collector 113 may be removed by the dust collector 113 while moving in one direction due to the electrodynamic wave generated by the plurality of pattern electrodes.

The disclosure provides the electrical dust collector 110 having a dust collecting function for collecting foreign substances and a cleaning function for removing the collected foreign substances by arranging the plurality of pattern electrodes on the dust collector 113.

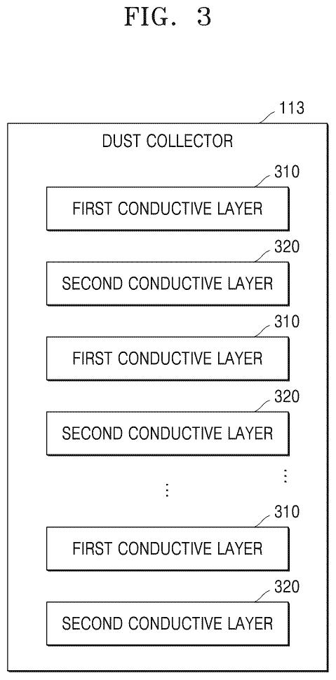

FIG. 3 is a block diagram showing the dust collector 113 of the electrical dust collector 110 according to one or more embodiments of the disclosure. The dust collector 113 may include a first conductive layer 310 and a second conductive layer 320.

The dust collector 113 may include at least one first conductive layer 310 and at least one second conductive layer 320. For example, the dust collector 113 may include a plurality of first conductive layers 310 and a plurality of second conductive layers 320. The first conductive layer 310 and the second conductive layer 320 that are provided in the dust collector 113 may be alternatively arranged. For example, in the dust collector 113, the plurality of first conductive layers 310 and the plurality of second conductive layers 320 may be alternately stacked while facing each other in the order of the first conductive layer 310, the second conductive layer 320, the first conductive layer 310, and the second conductive layer 320.

The first conductive layer 310 may include a plurality of pattern electrodes. The first conductive layer 310 may include a patterned electrode. The electrical dust collector 110 may apply a direct current (DC) voltage to the first conductive layer 310 when collecting foreign substances. The electrical dust collector 110 may apply an alternating current (AC) voltage or a pulse width modulation (PWM) voltage to the first conductive layer 310 when removing foreign substances collected in the dust collector 113.

The second conductive layer 320 may be adjacent to the first conductive layer 310. The second conductive layer 320 may include an integral electrode. For example, the second conductive layer 320 may include a plane-shaped electrode. However, without being limited thereto, the second conductive layer 320 may include at least one pattern electrode. The electrical dust collector 110 may apply a ground (DC) voltage or a reference DC voltage to the second conductive layer 320 when collecting foreign substances. When the electrical dust collector 110 applies an AC voltage to the first conductive layer 310 to remove foreign substances collected in the dust collector 113, the voltage used when collecting foreign substances or a reference AC voltage may be applied to the second conductive layer 320. The voltage used when collecting foreign substances may include a ground voltage. When the electrical dust collector 110 applies a PWM voltage to the first conductive layer 310 to remove foreign substances collected in the dust collector 113, the voltage used when collecting foreign substances or a reference PWM voltage may be applied to the second conductive layer 320. The voltage used to collect foreign substances may include an average DC voltage of the PWM voltage.

In particular, the electrical dust collector 110 according to the disclosure may be provided to remove foreign substances that are accumulated in the first conductive layer 310 by collecting the foreign substances in the first conductive layer 310 of the dust collector 113, and thus the foreign substances may be accumulated in the first conductive layer 310 when collecting the foreign substances in the dust collector 113.

Accordingly, when collecting foreign substances in the dust collector 113, the electrical dust collector 110 according to the disclosure may cause the first conductive layer 310 to have a lower potential than the second conductive layer 320 when a polarity of the foreign substance charged in the charger 111 is positive (+). For example, the processor 115 of the electrical dust collector 110 may cause the first conductive layer 310 to have a negative (−) voltage and the second conductive layer 320 to have a ground voltage when the polarity of the charged foreign substance is positive (+). For example, the processor 115 may cause the first conductive layer 310 to have a ground voltage and the second conductive layer 320 to have a positive (+) voltage when the polarity of the charged foreign substance is positive (+).

When collecting foreign substances in the dust collector 113, the electrical dust collector 110 according to the disclosure may cause the first conductive layer 310 to have a higher potential than the second conductive layer 320 when a polarity of the foreign substance charged in the charger 111 is negative (−). For example, the processor 115 of the electrical dust collector 110 may cause the first conductive layer 310 to have a positive (+) voltage and the second conductive layer 320 to have a ground voltage when the polarity of the charged foreign substance is negative (−). For example, the processor 115 may cause the first conductive layer 310 to have a ground voltage and the second conductive layer 320 to have a negative (−) voltage when the polarity of the charged foreign substance is negative (−).

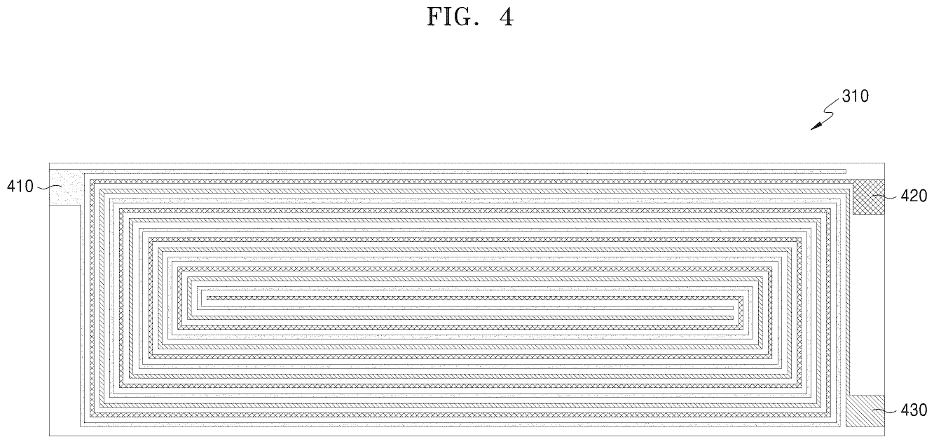

FIG. 4 is a diagram showing the first conductive layer 310 of the dust collector 113 according to one or more embodiments of the disclosure. The first conductive layer 310 may include a first pattern electrode 410, a second pattern electrode 420, and a third pattern electrode 430. The first conductive layer 310 according to FIG. 4 may receive a 3-phase voltage.

The first pattern electrode 410, the second pattern electrode 420, and the third pattern electrode 430 may be respective lines spaced at regular intervals. Each of the first pattern electrode 410, the second pattern electrode 420, and the third pattern electrode 430 may have a constant line width. The first pattern electrode 410, the second pattern electrode 420, and the third pattern electrode 430 may have a constant interval therebetween.

The first pattern electrode 410, the second pattern electrode 420, and the third pattern electrode 430 may be placed on the first conductive layer 310 such that there is no break in the line. Each of the first pattern electrode 410, the second pattern electrode 420, and the third pattern electrode 430 may be extended over the first conductive layer 310 to cover as much of the first conductive layer 310 as possible.

The first pattern electrode 410, the second pattern electrode 420, and the third pattern electrode 430 may each be placed in a spiral shape on the first conductive layer 310. At least one of an AC voltage or a PWM voltage having the same polarity as the charged foreign substance may be applied to each of the first pattern electrode 410, the second pattern electrode 420, and the third pattern electrode 430. The voltages respectively applied to the first pattern electrode 410, the second pattern electrode 420, and the third pattern electrode 430 may have a phase difference. Depending on the phase difference of the voltages respectively applied to the first pattern electrode 410, the second pattern electrode 420, and the third pattern electrode 430, foreign substances accumulated in the first conductive layer 310 may move in a certain direction.

An interval between the plurality of pattern electrodes 410, 420, and 430 may be less than or equal to a distance between the first conductive layer 310 and the second conductive layer 320. The interval between the first pattern electrode 410, the second pattern electrode 420, and the third pattern electrode 430 may be less than or equal to the distance between the first conductive layer 310 and the second conductive layer 320. For example, when the distance between the first conductive layer 310 and the second conductive layer 320 is 5 mm, the interval between the plurality of pattern electrodes 410, 420, and 430 may be 2 mm. For example, when the distance between the first conductive layer 310 and the second conductive layer 320 is 2 mm, the interval between the plurality of pattern electrodes 410, 420, and 430 may be 1 mm.

A line width of each of the plurality of pattern electrodes 410, 420, and 430 may be as thin as possible. The line width of each of the plurality of pattern electrodes 410, 420, and 430 may be less than or equal to 5 mm. The line width of each of the plurality of pattern electrodes 410, 420, and 430 may be set in consideration of the cost of forming the plurality of pattern electrodes 410, 420, and 430 on the first conductive layer 310 and the ease of forming the plurality of pattern electrodes 410, 420, and 430 on the first conductive layer 310. For example, the line width of each of the plurality of pattern electrodes 410, 420, and 430 may be set to about 1 mm or more and about 2 mm or less.

The distance between the first conductive layer 310 and the second conductive layer 320 may be as small as possible. As the distance between the first conductive layer 310 and the second conductive layer 320 decreases, the strength of the electric field formed between the first conductive layer 310 and the second conductive layer 320 may increase. For example, the distance between the first conductive layer 310 and the second conductive layer 320 may be set to be about 0.5 mm or more and about 1 mm or less.

The strength of the electric field formed between the plurality of pattern electrodes 410, 420, and 430 may be 3 kV/mm or less. When the strength of the electric field formed between the plurality of pattern electrodes 410, 420, and 430 is greater than 2 kV/mm, an insulation breakdown phenomenon in the air may occur. To prevent insulation breakdown from occurring between the plurality of pattern electrodes 410, 420, and 430, the strength of the electric field formed between the plurality of pattern electrodes 410, 420, and 430 may be limited. For example, when the interval between the plurality of pattern electrodes 410, 420, and 430 is 1 mm, the maximum strength of the AC voltage applied to the plurality of pattern electrodes 410, 420, and 430 may be 1.5 kV or less. For example, when the interval between the plurality of pattern electrodes 410, 420, and 430 is 1 mm, the maximum strength of the PWM voltage applied to the plurality of pattern electrodes 410, 420, and 430 may be 3 kV or less.

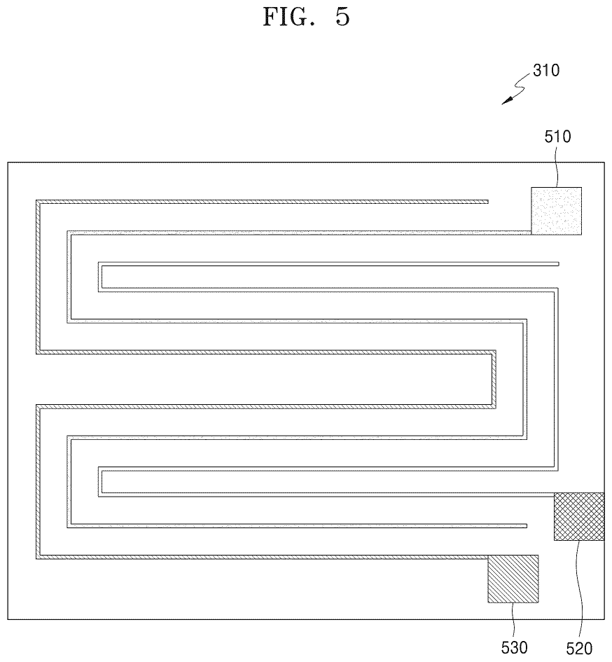

FIG. 5 is a diagram showing the first conductive layer 310 of the dust collector 113 according to one or more embodiments of the disclosure. The first conductive layer 310 may include a first pattern electrode 510, a second pattern electrode 520, and a third pattern electrode 530. The first conductive layer 310 according to FIG. 5 may receive a 3-phase voltage.

The first pattern electrode 510, the second pattern electrode 520, and the third pattern electrode 530 may be respective lines spaced at regular intervals. Each of the first pattern electrode 510, the second pattern electrode 520, and the third pattern electrode 530 may have a constant line width. The first pattern electrode 510, the second pattern electrode 520, and the third pattern electrode 530 may have a constant interval therebetween.

The first pattern electrode 510, the second pattern electrode 520, and the third pattern electrode 530 may be placed on the first conductive layer 310 such that there is no break in the line. Each of the first pattern electrode 510, the second pattern electrode 520, and the third pattern electrode 530 may be extended over the first conductive layer 310 to cover as much of the first conductive layer 310 as possible.

The first pattern electrode 510, the second pattern electrode 520, and the third pattern electrode 530 may each be placed in a zigzag shape on the first conductive layer 310. At least one of an AC voltage or a PWM voltage having the same polarity as the charged foreign substance may be applied to each of the first pattern electrode 510, the second pattern electrode 520, and the third pattern electrode 530. The voltages respectively applied to the first pattern electrode 510, the second pattern electrode 520, and the third pattern electrode 530 may have a phase difference. Depending on the phase difference of the voltages respectively applied to the first pattern electrode 510, the second pattern electrode 520, and the third pattern electrode 530, foreign substances accumulated in the first conductive layer 310 may move in a certain direction.

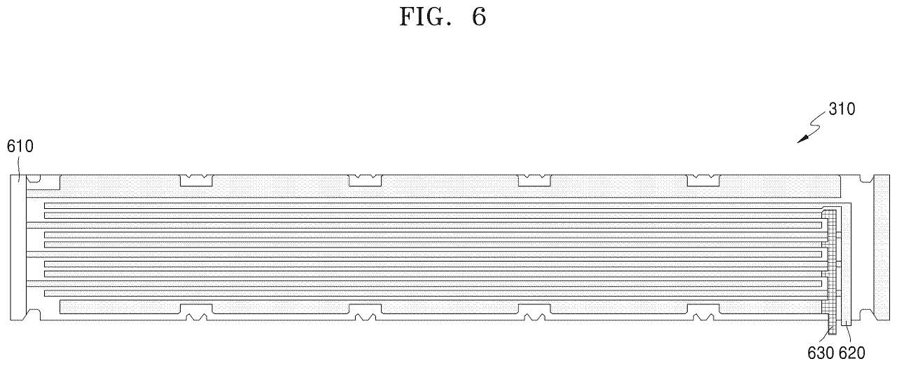

FIG. 6 is a diagram showing the first conductive layer 310 of the dust collector 113 according to one or more embodiments of the disclosure. The first conductive layer 310 may include a first pattern electrode 610, a second pattern electrode 620, and a third pattern electrode 630. The first conductive layer 310 according to FIG. 6 may receive a 3-phase voltage.

The first conductive layer 310 may include a plurality of layers. For example, the first conductive layer 310 may include two film layers. The first pattern electrode 610, the second pattern electrode 620, and the third pattern electrode 630 may be arranged at regular intervals on at least one layer from among the plurality of layers.

At least one of an AC voltage or a PWM voltage having the same polarity as the charged foreign substance may be applied to each of the first pattern electrode 610, the second pattern electrode 620, and the third pattern electrode 630. The voltages respectively applied to the first pattern electrode 610, the second pattern electrode 620, and the third pattern electrode 630 may have a phase difference. Depending on the phase difference of the voltages respectively applied to the first pattern electrode 610, the second pattern electrode 620, and the third pattern electrode 630, foreign substances accumulated in the first conductive layer 310 may move in a certain direction.

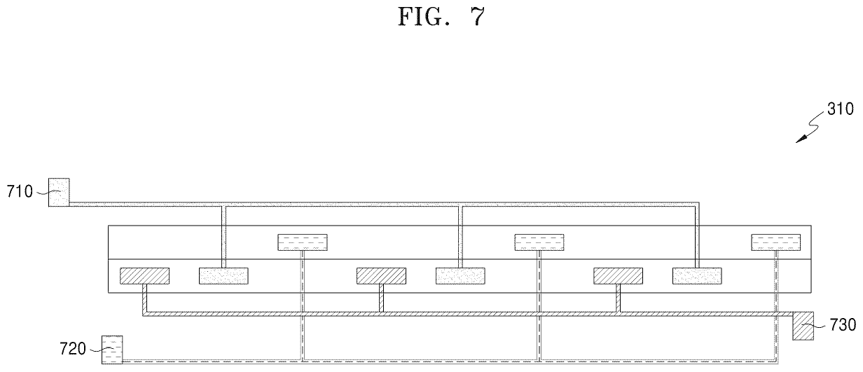

FIG. 7 is a diagram showing the first conductive layer 310 of the dust collector 113 according to one or more embodiments of the disclosure The first conductive layer 310 may include a first pattern electrode 710, a second pattern electrode 720, and a third pattern electrode 730. The first conductive layer 310 according to FIG. 7 may receive a 3-phase voltage.

The first conductive layer 310 may include a plurality of layers. For example, the first conductive layer 310 may include two film layers. The first pattern electrode 710, the second pattern electrode 720, and the third pattern electrode 730 may be arranged at regular intervals on at least one layer from among the plurality of layers.

At least one of an AC voltage or a PWM voltage having the same polarity as the charged foreign substance may be applied to each of the first pattern electrode 710, the second pattern electrode 720, and the third pattern electrode 730. The voltages respectively applied to the first pattern electrode 710, the second pattern electrode 720, and the third pattern electrode 730 may have a phase difference. Depending on the phase difference of the voltages respectively applied to the first pattern electrode 710, the second pattern electrode 720, and the third pattern electrode 730, foreign substances accumulated in the first conductive layer 310 may move in a certain direction.

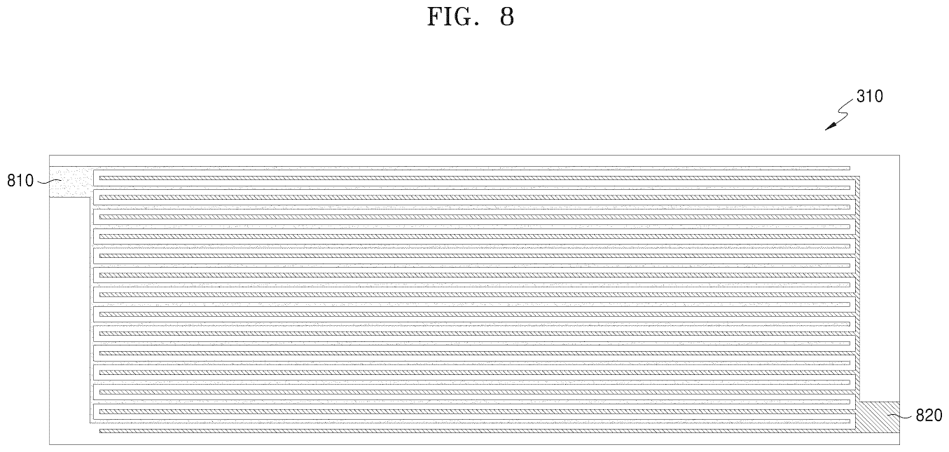

FIG. 8 is a diagram showing the first conductive layer 310 of the dust collector 113 according to one or more embodiments of the disclosure. The first conductive layer 310 may include a first pattern electrode 810 and a second pattern electrode 820. The first conductive layer 310 according to FIG. 8 may receive a 2-phase voltage.

The first pattern electrode 810 and the second pattern electrode 820 may be respective lines spaced at a regular interval. Each of the first pattern electrode 810 and the second pattern electrode 820 may have a constant line width. The first pattern electrode 810 and the second pattern electrode 820 may have a constant interval therebetween.

The first pattern electrode 810 and the second pattern electrode 820 may be placed on the first conductive layer 310 such that there is no break in the line. Each of the first pattern electrode 810 and the second pattern electrode 820 may be extended over the first conductive layer 310 to cover the first conductive layer 310 as much as possible.

The first pattern electrode 810 and the second pattern electrode 820 may be alternately arranged on the first conductive layer 310. At least one of an AC voltage or a PWM voltage having the same polarity as the charged foreign substance may be applied to each of the first pattern electrode 810 and the second pattern electrode 820. The voltages respectively applied to each of the first pattern electrode 810 and the second pattern electrode 820 may have a phase difference. Depending on the phase difference of the voltages respectively applied to the first pattern electrode 810 and the second pattern electrode 820, foreign substances accumulated in the first conductive layer 310 may move in a certain direction.

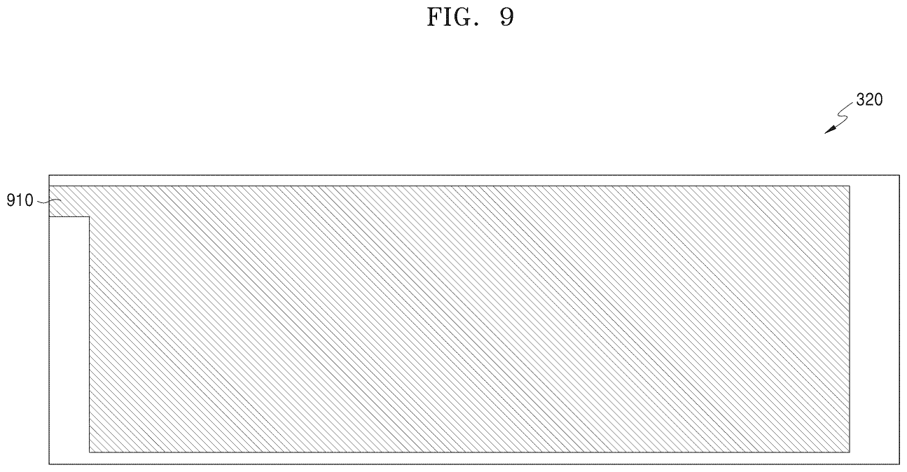

FIG. 9 is a diagram showing the second conductive layer 320 of the dust collector 113 according to one or more embodiments of the disclosure. The second conductive layer 320 may include an electrode 910. The electrode 910 may include an integral electrode. For example, the electrode 910 may be a plate-shaped electrode. However, without being limited thereto, and the electrode 910 may include at least one pattern electrode. The electrical dust collector 110 may apply a voltage to the electrode 910 when removing foreign substances collected in the dust collector 113. When a voltage is applied to the electrode 910, an electric field may be formed between the first conductive layer 310 and the second conductive layer 320 to move foreign substances accumulated in the first conductive layer 310 in a certain direction.

FIG. 10 is a graph showing a voltage applied to the first conductive layer 310 of the dust collector 113 according to one or more embodiments of the disclosure. FIG. 10 is a graph showing a voltage applied to the first conductive layer 310 when the electrical dust collector 110 collects foreign substances in the air.

When the electrical dust collector 110 collects foreign substances in the air, a DC voltage may be applied to the first conductive layer 310 of the dust collector 113. The magnitude of the DC voltage may be a first voltage V1.

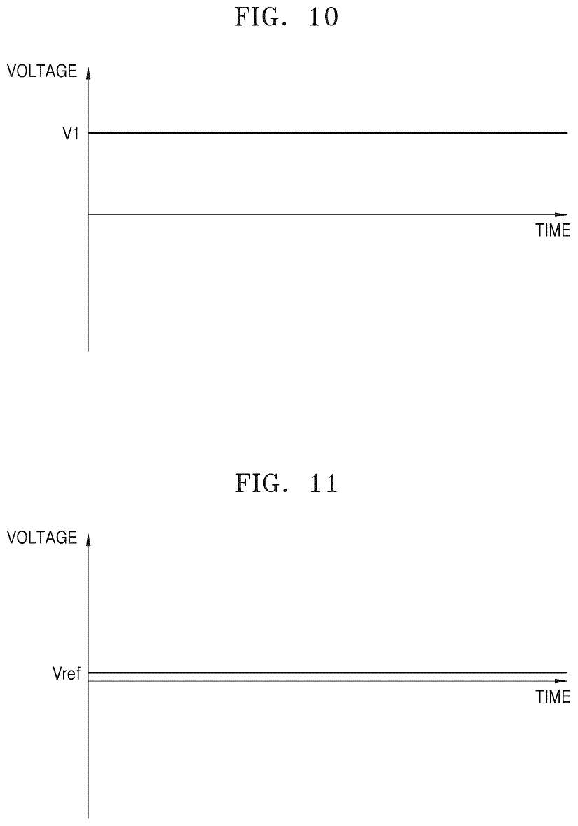

FIG. 11 is a graph showing a voltage applied to the second conductive layer 320 of the dust collector 113 according to one or more embodiments of the disclosure. FIG. 11 is a graph showing a voltage applied to the second conductive layer 320 when the electrical dust collector 110 collects foreign substances in the air.

When the electrical dust collector 110 collects foreign substances in the air, a reference DC voltage may be applied to the second conductive layer 320 of the dust collector 113. The magnitude of the reference DC voltage may be a reference voltage Vref. For example, the reference DC voltage may be a ground voltage.

FIG. 12 is a graph showing a voltage applied to the first conductive layer 310 of the dust collector 113 according to one or more embodiments of the disclosure. FIG. 12 is a graph showing a voltage applied to the first conductive layer 310 when the electrical dust collector 110 removes foreign substances collected in the dust collector 113.

When the electrical dust collector 110 removes foreign substances collected in the dust collector 113, an AC voltage may be applied to the first conductive layer 310 of the dust collector 113. For example, when the electrical dust collector 110 removes foreign substances collected in the dust collector 113, a sine-shaped AC voltage may be applied to the first conductive layer 310 of the dust collector 113. The magnitude of the AC voltage may be a second voltage V2.

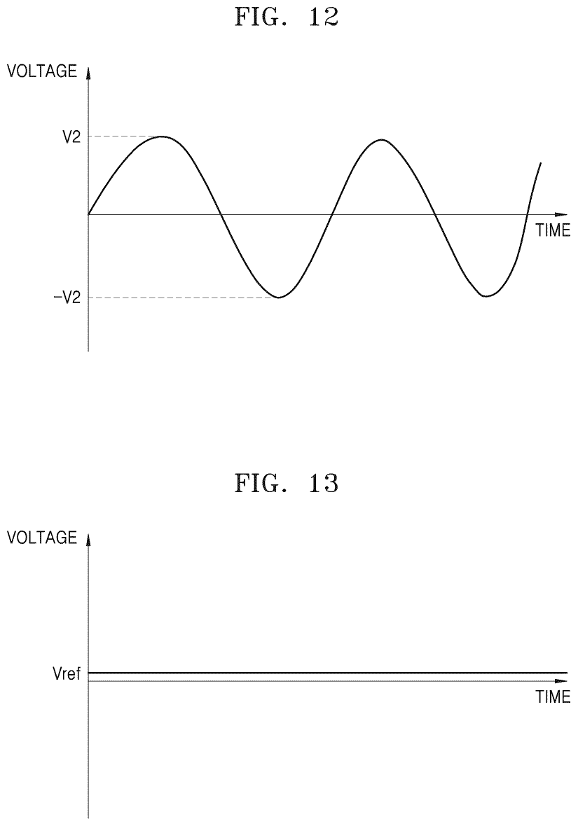

FIG. 13 is a graph showing a voltage applied to the second conductive layer 320 of the dust collector 113 according to one or more embodiments of the disclosure. FIG. 13 is a graph showing a voltage applied to the second conductive layer 320 when the electrical dust collector 110 removes foreign substances collected in the dust collector 113.

When the electrical dust collector 110 removes foreign substances collected in the dust collector 113, a reference DC voltage may be applied to the second conductive layer 320 of the dust collector 113. The magnitude of the reference DC voltage may be a reference voltage Vref. For example, the reference DC voltage may be a ground voltage.

However, the disclosure is not limited thereto, and when the electrical dust collector 110 removes foreign substances collected in the dust collector 113, a reference AC voltage may be applied to the second conductive layer 320 of the dust collector 113. The magnitude of the reference AC voltage may be less than the second voltage V2.

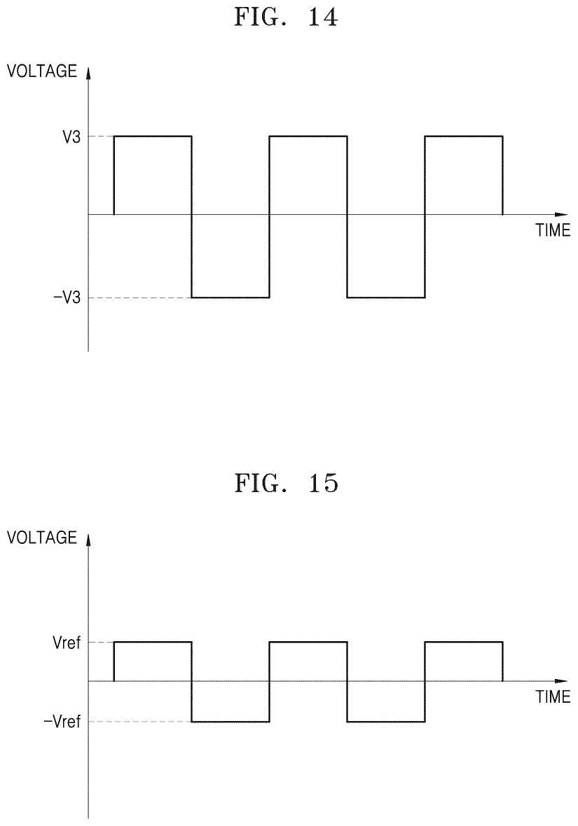

FIG. 14 is a graph showing a voltage applied to the first conductive layer 310 of the dust collector 113 according to one or more embodiments of the disclosure. FIG. 14 is a graph showing a voltage applied to the first conductive layer 310 when the electrical dust collector 110 removes foreign substances collected in the dust collector 113.

When the electrical dust collector 110 removes foreign substances collected in the dust collector 113, a PWM voltage may be applied to the first conductive layer 310 of the dust collector 113. For example, when the electrical dust collector 110 removes foreign substances collected in the dust collector 113, a square-shaped PWM voltage may be applied to the first conductive layer 310 of the dust collector 113. The magnitude of the PWM voltage may be a third voltage V3.

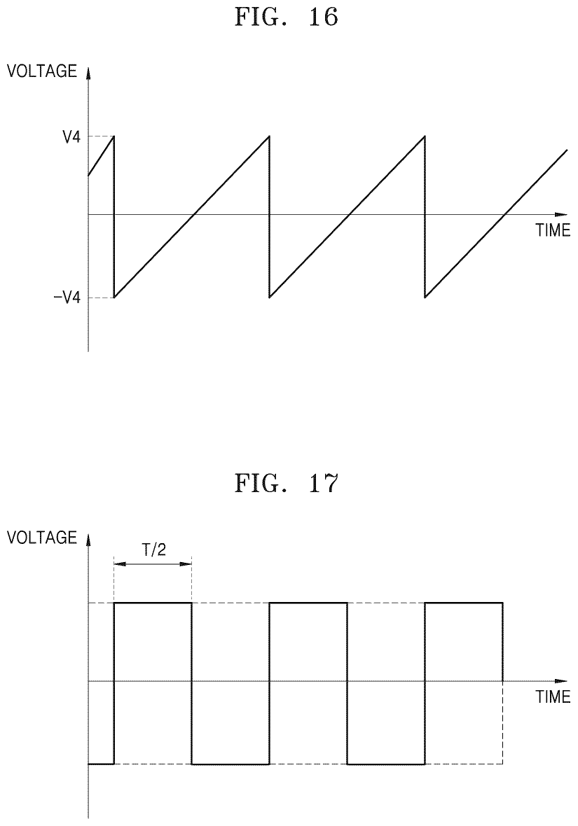

FIG. 15 is a graph showing a voltage applied to the second conductive layer 320 of the dust collector 113 according to one or more embodiments of the disclosure. FIG. 15 is a graph showing a voltage applied to the second conductive layer 320 when the electrical dust collector 110 removes foreign substances collected in the dust collector 113.

When the electrical dust collector 110 removes foreign substances collected in the dust collector 113, a reference PWM voltage may be applied to the second conductive layer 320 of the dust collector 113. The magnitude of the reference PWM voltage may be the reference voltage Vref.

However, the disclosure is not limited thereto, and when the electrical dust collector 110 removes foreign substances collected in the dust collector 113, a reference DC voltage may be applied to the second conductive layer 320 of the dust collector 113. The magnitude of the reference DC voltage may be less than the third voltage V3. For example, the reference DC voltage may be a ground voltage.

FIG. 16 is a graph showing a voltage applied to the first conductive layer 310 of the dust collector 113 according to one or more embodiments of the disclosure. FIG. 16 is a graph showing a voltage applied to the first conductive layer 310 when the electrical dust collector 110 removes foreign substances collected in the dust collector 113.

When the electrical dust collector 110 removes foreign substances collected in the dust collector 113, a ramp-shaped AC voltage may be applied to the first conductive layer 310 of the dust collector 113. The magnitude of the AC voltage may be a fourth voltage V4.

As such, a waveform of the AC voltage or PWM voltage applied to the first conductive layer 310 may have at least one of a sine shape, a square shape, or a ramp shape. For the electrical dust collector 110 to maximize an electrodynamic force in the dust collector 113, a square shape with a longest driving time at a maximum voltage may be most appropriate for the waveform of the AC voltage or PWM voltage applied to the first conductive layer 310.

FIG. 17 is a graph showing a 2-phase voltage applied to the first conductive layer 310 of the dust collector 113 according to one or more embodiments of the disclosure. FIG. 17 is a graph showing a 2-phase voltage applied to the first conductive layer 310 when the electrical dust collector 110 removes foreign substances collected in the dust collector 113.

The 2-phase voltage applied to the first conductive layer 310 may include a first phase voltage applied from a first power supply to the first conductive layer 310 and a second phase voltage applied from a second power supply to the first conductive layer 310. The first phase voltage and the second phase voltage may be applied to the first conductive layer 310 with a phase difference of half a period (T/2). The first phase voltage and the second phase voltage may be applied to the first conductive layer 310 with a phase difference of 180 degrees.

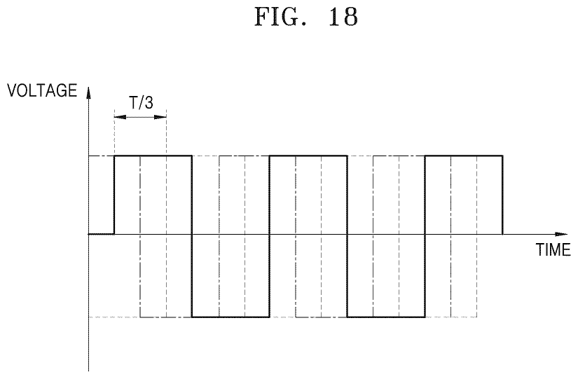

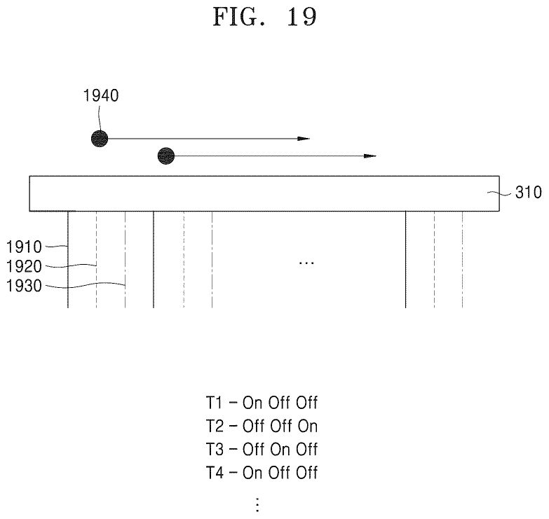

FIG. 18 is a graph showing a 3-phase voltage applied to the first conductive layer 310 of the dust collector 113 according to one or more embodiments of the disclosure. FIG. 18 is a graph showing a 3-phase voltage applied to the first conductive layer 310 when the electrical dust collector 110 removes foreign substances collected in the dust collector 113.

The 3-phase voltage applied to the first conductive layer 310 may include a first phase voltage applied from the first power supply to the first conductive layer 310, a second phase voltage applied from the second power supply to the first conductive layer 310, and a third phase voltage applied from a third power supply to the first conductive layer 310. Each of the first phase voltage, the second phase voltage, and the third phase voltage may be applied to the first conductive layer 310 with a phase difference of ⅓ of a period (T/3). Each of the first phase voltage, the second phase voltage, and the third phase voltage may be applied to the first conductive layer 310 with a phase difference of 120 degrees.

As such, a phase difference value of the AC voltage or PWM voltage applied to the first conductive layer 310 may be a value obtained by dividing a period of the AC voltage or PWM voltage by the number of phases of the AC voltage or PWM voltage. For example, when a 2-phase voltage is applied to the first conductive layer 310, the 2-phase voltage may be applied to the first conductive layer 310 with a phase difference of half a period (T/2), and when a 3-phase voltage is applied to the first conductive layer 310, the 3-phase voltage may be applied to the first conductive layer 310 with a phase difference of ⅓ of a period (T/3). Accordingly, when a 2-phase voltage is applied to the first conductive layer 310, the 2-phase voltage may be applied to the first conductive layer 310 with a phase difference of 180 degrees, and when a 3-phase voltage is applied to the first conductive layer 310, the 3-phase voltage may be applied to the first conductive layer 310 with a phase difference of 120 degrees.

A frequency of the AC voltage or PWM voltage applied to the first conductive layer 310 may be 5 Hz or more and 200 Hz or less. A frequency of the AC voltage or PWM voltage applied to the first conductive layer 310 may be set based on the size of the foreign substance, the density of the foreign substance, and the viscosity of the air. The size of the foreign substance may include a diameter value of the foreign substance. The density of the foreign substance and the viscosity of the air may have constant values in most cases. A frequency of the AC voltage or PWM voltage applied to the first conductive layer 310 may be set based on a diameter size of the foreign substance. For example, when a diameter value of the foreign substance is about 100 μm, a frequency of the AC voltage or PWM voltage applied to the first conductive layer 310 may be about 5 Hz. For example, when a diameter value of the foreign substance is about 20 μm, a frequency of the AC voltage or PWM voltage applied to the first conductive layer 310 may be about 200 Hz.

FIG. 19 is a diagram showing a case in which a foreign substance 1940 is moved by applying a voltage to the first conductive layer 310 of the dust collector 113 according to one or more embodiments of the disclosure. FIG. 19 is a diagram showing a case in which the foreign substance 1940 is moved by applying a 3-phase voltage to the first conductive layer 310 by using a first power supply 1910, a second power supply 1920, and a third power supply 1930.

The first power supply 1910, the second power supply 1920, and the third power supply 1930 may sequentially apply a voltage to the first conductive layer 310 to move the foreign substance 1940 collected on the first conductive layer 310 in one direction. At a first time point T1, the first power supply 1910 may be turned on (On), and the second power supply 1920 and the third power supply 1930 may be turned off (Off). At a second time point T2, the third power supply 1930 may be turned on (On), and the first power supply 1910 and the second power supply 1920 may be turned off (Off). At a third time point T3, the second power supply 1920 may be turned on (On), and the first power supply 1910 and the third power supply 1930 may be turned off (Off). At a fourth time point T4, the first power supply 1910 may be turned on (On), and the second power supply 1920 and the third power supply 1930 may be turned off (Off). In this case, the foreign substance 1940 may move from a portion in which the first power supply 1910 is placed toward a portion in which the third power supply 1930 is placed.

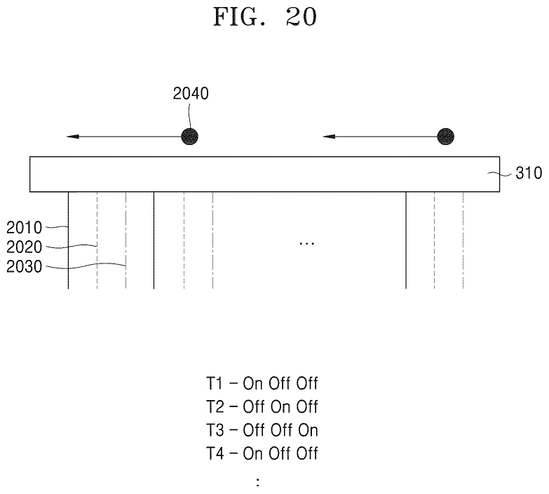

FIG. 20 is a diagram showing a case in which a foreign substance 2040 is moved by applying a voltage to the first conductive layer 310 of the dust collector 113 according to one or more embodiments of the disclosure. FIG. 20 is a diagram showing a case in which the foreign substance 2040 is moved by applying a 3-phase voltage to the first conductive layer 310 by using a first power supply 2010, a second power supply 2020, and a third power supply 2030.

The first power supply 2010, the second power supply 2020, and the third power supply 2030 may sequentially apply a voltage to the first conductive layer 310 to move the foreign substance 2040 collected on the first conductive layer 310 in one direction. At a first time point T1, the first power supply 2010 may be turned on (On), and the second power supply 2020 and the third power supply 2030 may be turned off (Off). At the second time point T2, the second power supply 2020 may be turned on (On), and the first power supply 2010 and the third power supply 2030 may be turned off (Off). At the third time point T3, the third power supply 2030 may be turned on (On), and the first power supply 2010 and the second power supply 2020 may be turned off (Off). At the fourth time point T4, the first power supply 2010 may be turned on (On), and the second power supply 2020 and the third power supply 2030 may be turned off (Off). In this case, the foreign substance 1940 may move from a portion in which the third power supply 2030 is placed toward a portion in which the first power supply 2010 is placed.

The electrical dust collector 110 according to one or more embodiments of the disclosure may remove foreign substances electrodynamically collected on the first conductive layer 310 of the dust collector 113 based on a governing equation. The governing equation is as follows, and a force received by the foreign substance collected on the first conductive layer 310 is expressed as Equations 1 to 5.

$${\vec{F}}_{E} = {n}_{p} e \vec{E} \qquad Equation 1$$

Equation 1 represents an electrostatic force (Coulomb Force) exerted to the foreign substance collected on the first conductive layer 310. In Equation 1, np may be a rotation number of a foreign substance. In Equation 1, E may be an electric field formed in the first conductive layer 310.

$${\vec{F}}_{vdw} = \frac{Ar}{12 {s}^{2}} \qquad Equation 2$$

Equation 2 represents an adhesion force (van der Waals force) exerted to the foreign substance collected on the first conductive layer 310. In Equation 2, r may be a radius of the foreign substance. In Equation 2, s may be a distance between an outer surface of the dust collector 113 and the foreign substance.

$${\vec{F}}_{DEP} = 2 {πε}_{f} {R}^{3} K ∇ {E}^{2} \qquad Equation 3$$

Equation 3 represents a dielectrophoretic force exerted to the foreign substance collected on the first conductive layer 310. In Equation 3, Er may be a dielectric constant of a fluid (e.g., air) around the first conductive layer 310. In Equation 3, R may be a radius of the foreign substance. In Equation 3, E may be an electric field formed in the first conductive layer 310.

$${\vec{F}}_{D} = \frac{18 μ {m}_{p}}{{ρ}_{p} {d}_{p}^{2}} ( \vec{u} - \vec{v} ) \qquad Equation 4$$

Equation 4 represents a drag force exerted to the foreign substance collected on the first conductive layer 310. In Equation 4, u may be a velocity of a fluid around the first conductive layer 310. In Equation 4, v may be a velocity of the foreign substance.

$${\vec{F}}_{DEP} + {F}_{D} + {F}_{E} + {F}_{vdw} = {m}_{p} \frac{d \vec{v}}{dt} \qquad Equation 5$$

Equation 5 represents a force exerted to the foreign substance collected on the first conductive layer 310. Equation 5 is a governing equation for explaining an operation of the electrical dust collector 110 according to the disclosure. When the electrical dust collector 110 removes foreign substances electrodynamically collected on the first conductive layer 310 of the dust collector 113, electrostatic force, adhesion force, dielectrophoretic force, and drag force may be applied to the foreign substances. When the electrical dust collector 110 removes foreign substances electrodynamically collected on the first conductive layer 310 of the dust collector 113, the foreign substances may be separated and removed from the first conductive layer 310 by using electrostatic force and dielectrophoretic force, which are electrodynamic forces.

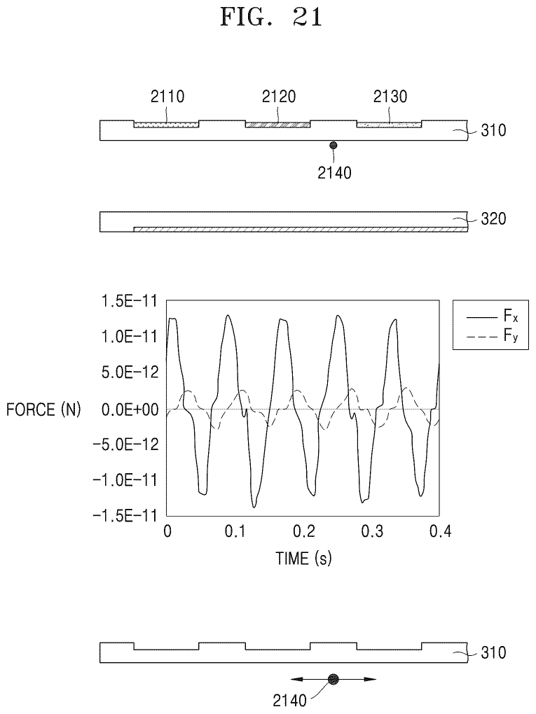

FIG. 21 is a diagram showing an electrodynamic force applied to a foreign substance 2140 by the electrical dust collector 110 according to one or more embodiments of the disclosure.

A first pattern electrode 2110, a second pattern electrode 2120, and a third pattern electrode 2130 may be arranged on the first conductive layer 310. The foreign substance 2140 may be collected on the first conductive layer 310.

When the electrical dust collector 110 removes the foreign substance 2140 from the first conductive layer 310, an electrodynamic force may be applied. When the foreign substance 2140 is located between the second pattern electrode 2120 and the third pattern electrode 2130, the foreign substance 2140 may receive an electrodynamic force in a horizontal direction.

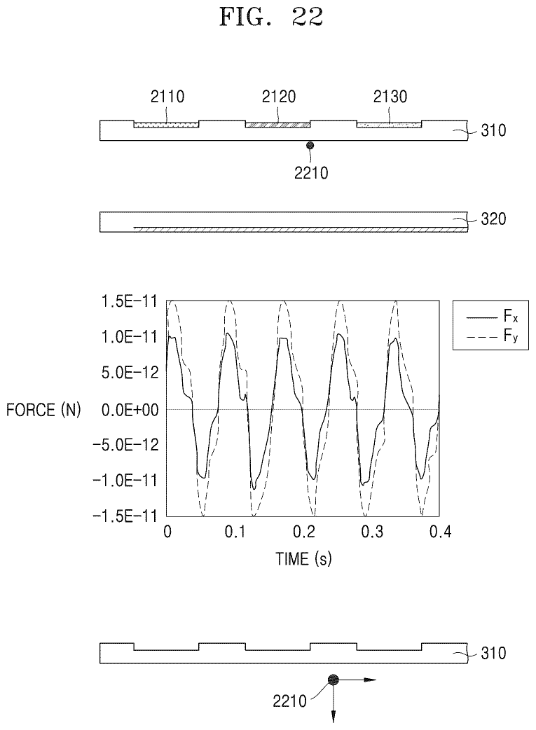

FIG. 22 is a diagram showing an electrodynamic force applied to a foreign substance 2210 by the electrical dust collector 110 according to one or more embodiments of the disclosure.

The first pattern electrode 2110, the second pattern electrode 2120, and the third pattern electrode 2130 may be arranged on the first conductive layer 310. The foreign substance 2210 may be collected on the first conductive layer 310.

When the electrical dust collector 110 removes the foreign substance 2210 from the first conductive layer 310, an electrodynamic force may be applied. When the foreign substance 2210 is located at an end of the second pattern electrode 2120, the foreign substance 2210 may receive the electrodynamic force in horizontal and vertical directions.

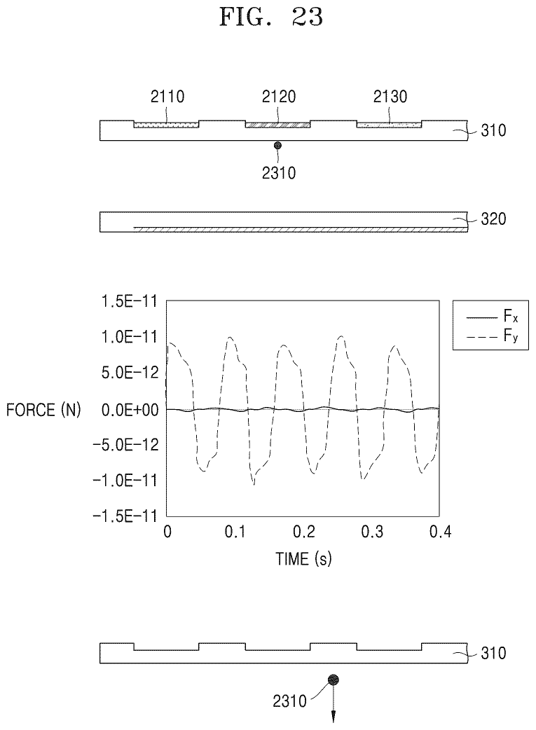

FIG. 23 is a diagram showing an electrodynamic force applied to a foreign substance 2310 by the electrical dust collector 110 according to one or more embodiments of the disclosure.

The first pattern electrode 2110, the second pattern electrode 2120, and the third pattern electrode 2130 may be arranged on the first conductive layer 310. The foreign substance 2310 may be collected on the first conductive layer 310.

When the electrical dust collector 110 removes the foreign substance 2310 from the first conductive layer 310, an electrodynamic force may be applied. When the foreign substance 2310 is located at a central portion of the second pattern electrode 2120, the foreign substance 2310 may receive the electrodynamic force in a vertical direction.

The electrical dust collector 110 may apply the electrodynamic force in different directions depending on the location of the foreign substance. The electrical dust collector 110 may move foreign substances outside the first conductive layer 310 by the electrodynamic force. When the foreign substance is located in the central portion of the pattern electrode, a vertical electrodynamic force may be applied to the foreign substance, which may degrade the performance of removing the foreign substance. Accordingly, as the line width of each of the first pattern electrode 2110, the second pattern electrode 2120, and the third pattern electrode 2130 that are arranged on the first conductive layer 310 decreases, the performance of removing foreign substances may be improved. An interval between the first pattern electrode 2110, the second pattern electrode 2120, and the third pattern electrode 2130 needs to be less than or equal to a distance between the first conductive layer 310 and the second conductive layer 320 such that an electrodynamic force may be formed in a horizontal direction.

When 2-phase power is used, a vertical force is continuously applied upward through the first conductive layer, and thus foreign substances may be removed from the first conductive layer. However, when 2-phase power is used, a direction of movement of the foreign substance may change while a direction of an electric field changes periodically between the plurality of pattern electrodes. When 2-phase power is used, the direction of movement of the foreign substance may change periodically and it may not be easy to move the foreign substance in a horizontal direction.

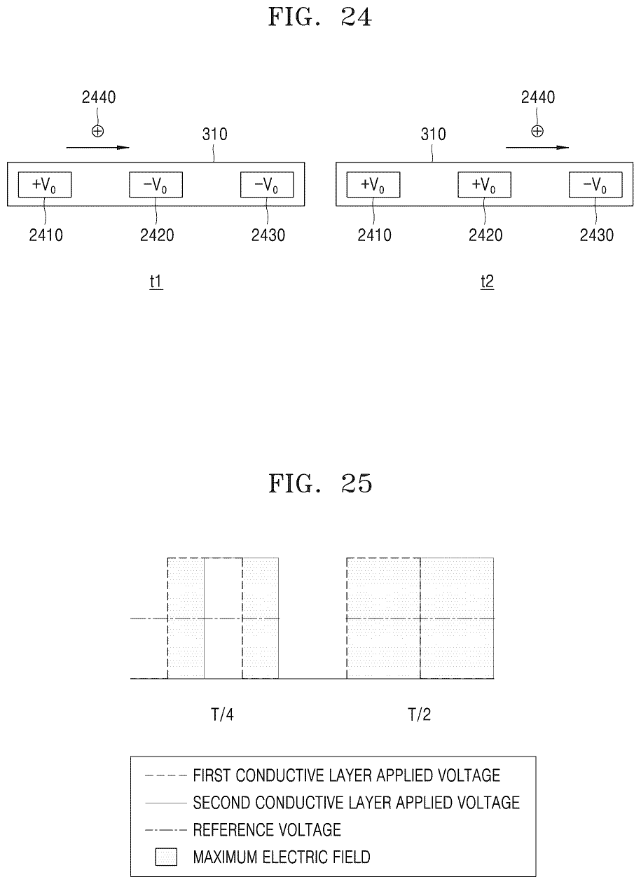

FIG. 24 is a diagram showing movement of a foreign substance 2440 based on a 3-phase voltage applied to the first conductive layer 310 by the electrical dust collector 110 according to one or more embodiments of the disclosure.

A first pattern electrode 2410, a second pattern electrode 2420, and a third pattern electrode 2430 may be arranged on the first conductive layer 310. The foreign substance 2440 may move on the first conductive layer 310.

At a first time point t1, the first pattern electrode 2410 may have a positive voltage +V₀. At the first time point t1, the second pattern electrode 2420 and the third pattern electrode 2430 may have a negative voltage −V₀.

At a second time point t2, the first pattern electrode 2410 and the second pattern electrode 2420 may have the positive voltage +V₀. At the first time point t1, the third pattern electrode 2430 may have the negative voltage −V₀.

When power of three or more phases is used, the electric field and electrodynamic force exerted between the first pattern electrode 2410, the second pattern electrode 2420, and the third pattern electrode 2430 may be controlled at intervals of one-third of a period (period/3). When power of three or more phases is used, the electrical dust collector 110 may move the foreign substance 2440 only in one horizontal direction. When power of three or more phases is used, the electrical dust collector 110 may continuously move the foreign substance 2440 in a horizontal direction, and thus the performance of removing the foreign substance 2440 from the first conductive layer 310 may be improved.

FIG. 25 is a graph showing an electric field based on a phase difference of a voltage applied to the first conductive layer 310 by the electrical dust collector 110 according to one or more embodiments of the disclosure.

The voltage applied by the electrical dust collector 110 to each of the plurality of pattern electrodes of the first conductive layer 310 may have a phase difference. The strength of the electric field may change depending on a phase difference of the voltage applied to each of the plurality of pattern electrodes by the electrical dust collector 110. When the phase difference is one-quarter of a period (T/4), a time interval during which the strength of the electric field is maximum may be half of the entire time interval. When the phase difference is half a period (T/2), a time interval during which the strength of the electric field is maximum may be the entire time interval. It may be seen that a phase difference that maximizes a force applied to a foreign substance is ½ of a period.

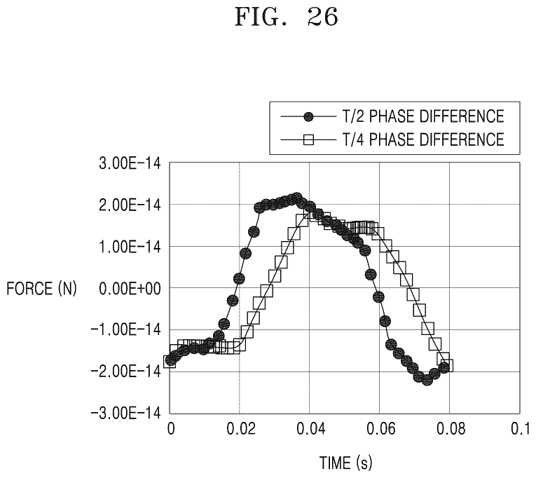

FIG. 26 is a diagram showing an amount of impact based on a phase difference of a voltage applied to the first conductive layer 310 by the electrical dust collector 110 according to one or more embodiments of the disclosure. FIG. 26 is a graph showing a force applied vertically to a foreign substance.

It may be seen that when a phase difference of a voltage applied to each of the plurality of pattern electrodes of the first conductive layer 310 in the electrical dust collector 110 is ½ of a period (T/2), the amount of impact applied to the foreign substance increases by about 10% or more and about 40% or less compared to when the phase difference is ¼ of the period (T/4).

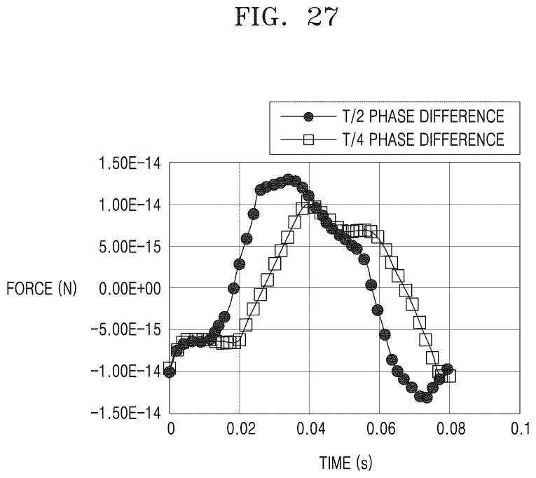

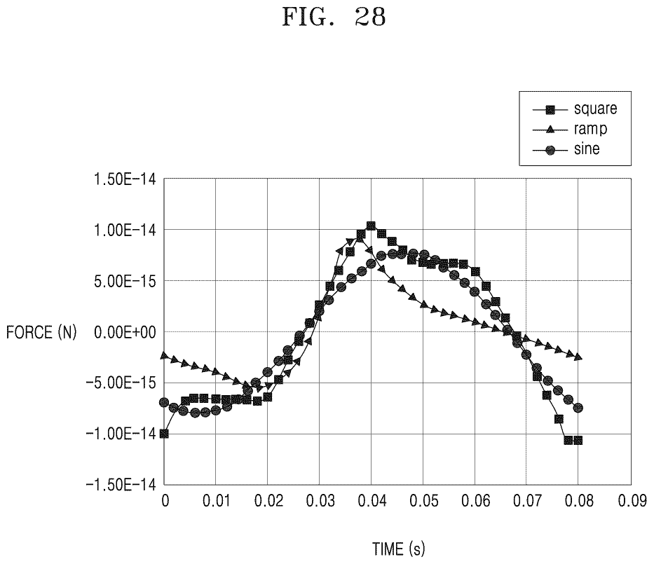

FIG. 27 is a diagram showing an amount of impact based on a phase difference of a voltage applied to the first conductive layer 310 by the electrical dust collector 110 according to one or more embodiments of the disclosure. FIG. 27 is a graph showing a force applied horizontally to a foreign substance.

It may be seen that when a phase difference of a voltage applied to each of the plurality of pattern electrodes of the first conductive layer 310 in the electrical dust collector 110 is ½ of a period (T/2), the amount of impact applied to the foreign substance increases by about 10% or more and about 40% or less compared to when the phase difference is ¼ of the period (T/4).

FIG. 28 is a diagram showing an amount of impact based on a waveform of a voltage applied to the first conductive layer 310 by the electrical dust collector 110 according to one or more embodiments of the disclosure. FIG. 28 is a graph showing a force applied horizontally to a foreign substance.

The amount of impact applied to a foreign substance may change depending on a waveform of a voltage applied to each of the plurality of pattern electrodes of the first conductive layer 310 in the electrical dust collector 110. When the waveform of the voltage applied to each of the plurality of pattern electrodes of the first conductive layer 310 in the electrical dust collector 110 has a square waveform, the electric field of the maximum strength may be applied for the longest time period. Accordingly, it may be seen that when the voltage applied to each of the plurality of pattern electrodes of the first conductive layer 310 in the electrical dust collector 110 has a square waveform, the amount of impact applied to the foreign substance has a maximum value.

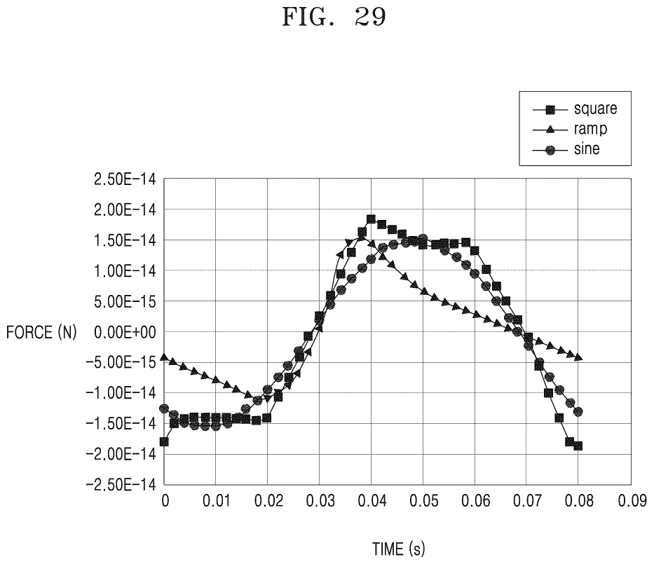

FIG. 29 is a diagram showing an amount of impact based on a waveform of a voltage applied to the first conductive layer 310 by the electrical dust collector 110 according to one or more embodiments of the disclosure. FIG. 29 is a graph showing a force applied vertically to a foreign substance.

The amount of impact applied to a foreign substance may change depending on a waveform of the voltage applied to each of the plurality of pattern electrodes of the first conductive layer 310 in the electrical dust collector 110. When the waveform of the voltage applied to each of the plurality of pattern electrodes of the first conductive layer 310 in the electrical dust collector 110 has a square waveform, the electric field of the maximum strength may be applied for the longest time period. Accordingly, it may be seen that when the voltage applied to each of the plurality of pattern electrodes of the first conductive layer 310 in the electrical dust collector 110 has a square waveform, the amount of impact applied to the foreign substance has a maximum value.

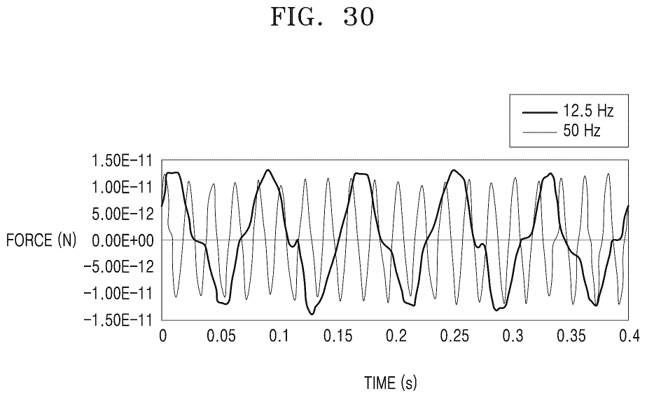

FIG. 30 is a diagram showing an amount of impact based on a frequency of a voltage applied to the first conductive layer 310 by the electrical dust collector 110 according to one or more embodiments of the disclosure.

The amount of impact applied to a foreign substance may change depending on a frequency of the voltage applied to each of the plurality of pattern electrodes of the first conductive layer 310 in the electrical dust collector 110. As a frequency of the voltage applied to each of the plurality of pattern electrodes of the first conductive layer 310 in the electrical dust collector 110 increases, the magnitude of a force exerted to the foreign substance may increase. However, as a frequency of the voltage applied to each of the plurality of pattern electrodes of the first conductive layer 310 in the electrical dust collector 110 increases, a time during which a force is applied to the foreign substance may decrease. Accordingly, the frequency of the voltage applied to each of the plurality of pattern electrodes of the first conductive layer 310 in the electrical dust collector 110 may be set to a frequency at which the foreign substance is moved without generating plasma between the plurality of pattern electrodes of the first conductive layer 310. For example, the frequency of the voltage applied to each of the plurality of pattern electrodes of the first conductive layer 310 in the electrical dust collector 110 may be set to about 5 Hz or more and about 200 Hz or less.

The disclosure provides an electrical dust collector that simultaneously has a function of collecting foreign substances and a function of cleaning the collected foreign substances by arranging patterned electrodes in the dust collector to form an electric field, a method of controlling the electrical dust collector, and an air handler including the electrical dust collector.

An electrical dust collector according to the disclosure may include a charger that charges a foreign substance in the air, a dust collector that collects the charged foreign substance and removes the foreign substance from the air, and at least one processor, and in this case, the dust collector may include a first conductive layer including a plurality of pattern electrodes, and a second conductive layer adjacent to the first conductive layer, the at least one processor may apply, to the first conductive layer, at least one of an AC voltage or a PWM voltage having the same polarity as the charged foreign substance, when applying the AC voltage to the first conductive layer, may apply, to the second conductive layer, a voltage used when collecting the foreign substance or a reference AC voltage, and when applying the PWM voltage to the first conductive layer, may apply, to the second conductive layer, the voltage used when collecting the foreign substance or the reference PWM voltage.

In one or more embodiments of the disclosure, the plurality of pattern electrodes may be respective lines spaced at regular intervals.

In one or more embodiments of the disclosure, each of the plurality of pattern electrodes may be placed in a spiral shape or a zigzag shape on the first conductive layer.

In one or more embodiments of the disclosure, an interval between the plurality of pattern electrodes may be less than or equal to a distance between the first conductive layer and the second conductive layer.

In one or more embodiments of the disclosure, the strength of the electric field formed between the plurality of pattern electrodes may be 3 kV/mm or less.

In one or more embodiments of the disclosure, a waveform of the AC voltage or the PWM voltage applied to the first conductive layer may be at least one of a sine shape, a square shape, or a ramp shape.

In one or more embodiments of the disclosure, a phase difference value of the AC voltage or the PWM voltage applied to the first conductive layer may be a value obtained by dividing a period of the AC voltage or the PWM voltage by the number of phases of the AC voltage or the PWM voltage.

In one or more embodiments of the disclosure, a frequency of the AC voltage or the PWM voltage applied to the first conductive layer may be set to about 5 Hz or more and about 200 Hz or less.

A method of controlling an electrical dust collector according to the disclosure may include applying, to a first conductive layer including a plurality of pattern electrodes, at least one of an AC voltage or a PWM voltage having the same polarity as a charged foreign substance, applying, to a second conductive layer adjacent to the first conductive layer, a voltage used when collecting the foreign substance or a reference AC voltage when applying the AC voltage to the first conductive layer, and applying, to the first conductive layer, a voltage used when collecting the foreign substance or a reference PWM voltage to the second conductive layer when applying the PWM voltage.

In one or more embodiments of the disclosure, the plurality of pattern electrodes may be respective lines spaced at regular intervals.

In one or more embodiments of the disclosure, each of the plurality of pattern electrodes may be placed in a spiral shape or a zigzag shape on the first conductive layer.

In one or more embodiments of the disclosure, an interval between the plurality of pattern electrodes may be less than or equal to a distance between the first conductive layer and the second conductive layer.

In one or more embodiments of the disclosure, the strength of the electric field formed between the plurality of pattern electrodes may be 3 kV/mm or less.

In one or more embodiments of the disclosure, a waveform of the AC voltage or the PWM voltage applied to the first conductive layer may be at least one of a sine shape, a square shape, or a ramp shape.

In one or more embodiments of the disclosure, a phase difference value of the AC voltage or the PWM voltage applied to the first conductive layer may be a value obtained by dividing a period of the AC voltage or the PWM voltage by the number of phases of the AC voltage or the PWM voltage.

The air handler according to the disclosure may include an electrical dust collector including a charger that charges a foreign substance in the air, a dust collector that collects the charged foreign substance and removes the foreign substance from the air, and at least one processor, and in this case, the dust collector may include a first conductive layer including a plurality of pattern electrodes, and a second conductive layer adjacent to the first conductive layer, the at least one processor may apply, to the first conductive layer, at least one of an AC voltage or a PWM voltage having the same polarity as the charged foreign substance, when applying the AC voltage to the first conductive layer, may apply, to the second conductive layer, a voltage used when collecting the foreign substance or a reference AC voltage, and when applying the PWM voltage to the first conductive layer, may apply, to the second conductive layer, the voltage used when collecting the foreign substance or the reference PWM voltage.

In one or more embodiments of the disclosure, the plurality of pattern electrodes may be respective lines spaced at regular intervals.

In one or more embodiments of the disclosure, each of the plurality of pattern electrodes may be placed in a spiral shape or a zigzag shape on the first conductive layer.

In one or more embodiments of the disclosure, an interval between the plurality of pattern electrodes may be less than or equal to a distance between the first conductive layer and the second conductive layer.

In one or more embodiments of the disclosure, the strength of the electric field formed between the plurality of pattern electrodes may be 3 kV/mm or less.

An electrical dust collector, a method of the electrical dust collector, and an air handler including the electrical dust collector according to the disclosure may efficiently collect a foreign substance by maintaining the strength of an electric field of a dust collector constant.

The electrical dust collector, the method of the electrical dust collector, and the air handler including the electrical dust collector according to the disclosure may reduce a white corona phenomenon by maintaining the electric field of a dust collector constant and uniform to prevent excessive accumulation of charges.

The electrical dust collector, the method of the electrical dust collector, and the air handler including the electrical dust collector according to the disclosure may effectively remove a foreign substance collected in a dust collector to reduce damage to the dust collector.

A method according to one or more embodiments may be implemented in the form of program commands that may be executed through various computer devices and recorded in a computer-readable medium. The computer-readable medium may include a program command, a data file, and a data structure alone or in combination. The program commands recorded in the medium may be those specifically designed and configured for the disclosure or may be known and available to those of skill in the art of computer software. Examples of a computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include a machine language code generated by a compiler and a high-level language code executable by a computer using an interpreter and the like.

One or more embodiments may also be implemented in the form of a recording medium containing computer-executable instructions, such as program modules executed by a computer. Computer-readable media may be any available media that are to be accessed by a computer, and includes both volatile and nonvolatile media, removable and non-removable media. Computer-readable media may include both computer storage media and communication media. Computer storage media includes both volatile and nonvolatile, removable and non-removable media implemented in any method or technology for storage of information such as computer-readable instructions, data structures, program modules or other data. Communication media typically includes computer readable instructions, data structures, program modules, or other data in a modulated data signal such as a carrier wave, or other transport mechanism, and includes any information delivery media. One or more embodiments may also be implemented as a computer program or computer program product including computer-executable instructions, such as a computer program executed by a computer.

The device-readable storage medium may be provided in the form of a non-transitory storage medium. Here, the term ‘non-transitory storage medium’ simply means a tangible device that does not contain signals (e.g. electromagnetic waves), and the term does not distinguish between cases in which data is stored semi-permanently or temporarily on a storage medium. For example, the ‘non-transitory storage medium’ may include a buffer in which data is temporarily stored.

According to one or more embodiments, the methods according to one or more embodiments disclosed herein may be provided as included in a computer program product. The computer program product may be traded between sellers and buyers as commodities. The computer program product may be distributed in the form of a device-readable storage medium (e.g., a compact disc read only memory (CD-ROM)), or may be distributed online (e.g., by download or upload) via an application store or directly between two user devices (e.g., smartphones). In the case of online distribution, at least a portion of the computer program product (e.g., a downloadable app) may be temporarily stored or temporarily generated in a device-readable storage medium, such as the memory of a server of a manufacturer, a server of an application store, or an intermediary server.

What is claimed is:

1. An electrical dust collector comprising:
a charger configured to charge a foreign substance in air;
a dust collector configured to collect the charged foreign substance and to remove the charged foreign substance from the air, the dust collector comprising:
a first conductive layer comprising a plurality of pattern electrodes; and
a second conductive layer adjacent to the first conductive layer;
memory storing one or more instructions; and
at least one processor,
wherein the one or more instructions, when executed by the at least one processor individually or collectively, cause the electrical dust collector to:
apply, to the first conductive layer, a voltage with a same polarity as the charged foreign substance, wherein the voltage comprises at least one of an alternating current (AC) voltage or a pulse width modulation (PWM) voltage,
based on the voltage being the AC voltage, apply to the second conductive layer a voltage used when collecting the charged foreign substance or a reference AC voltage, and
based on the voltage being the PWM voltage, apply to the second conductive layer the voltage used when collecting the charged foreign substance or a reference PWM voltage.

2. The electrical dust collector of claim 1, wherein the plurality of pattern electrodes are respective lines spaced at regular intervals.

3. The electrical dust collector of claim 1, wherein each of the plurality of pattern electrodes is in a spiral shape or a zigzag shape on the first conductive layer.

4. The electrical dust collector of claim 1, wherein an interval between the plurality of pattern electrodes is less than or equal to a distance between the first conductive layer and the second conductive layer.

5. The electrical dust collector of claim 1, wherein a strength of an electric field formed between the plurality of pattern electrodes is 3 kV/mm or less.

6. The electrical dust collector of claim 1, wherein a waveform of the voltage comprises at least one of a sine shape, a square shape, or a ramp shape.

7. The electrical dust collector of claim 1, wherein a phase difference value of the voltage comprises a quotient of a period of the voltage and a number of phases of the voltage.

8. The electrical dust collector of claim 1, wherein a frequency of the voltage is greater than or equal to 5 Hz and less than or equal to 200 Hz.

9. A method of controlling an electrical dust collector, the method comprising:
applying, to a first conductive layer of the electrical dust collector, a voltage with a same polarity as a charged foreign substance, wherein the first conductive layer comprises a plurality of pattern electrodes, and wherein the voltage comprises at least one of an alternative current (AC) voltage or a pulse width modulation (PWM) voltage;
based on the voltage being the AC voltage, applying to a second conductive layer of the electrical dust collector a voltage used when collecting the charged foreign substance or a reference AC voltage, wherein the second conductive layer is adjacent to the first conductive layer; and
based on the voltage being the PWM voltage, applying to the second conductive layer the voltage used when collecting the charged foreign substance or a reference PWM voltage.

10. The method of claim 9, wherein the plurality of pattern electrodes are respective lines spaced at regular intervals.

11. The method of claim 9, wherein each of the plurality of pattern electrodes is in a spiral shape or a zigzag shape on the first conductive layer.

12. The method of claim 9, wherein an interval between the plurality of pattern electrodes is less than or equal to a distance between the first conductive layer and the second conductive layer.

13. The method of claim 9, wherein a strength of an electric field formed between the plurality of pattern electrodes is 3 kV/mm or less.

14. The method of claim 9, wherein a waveform of the voltage comprises at least one of a sine shape, a square shape, or a ramp shape.

15. The method claim 9, wherein a phase difference value of the voltage comprises a quotient of a period of the voltage and a number of phases of the voltage.

16. An air handler comprising:
an electrical dust collector comprising:
a charger configured to charge a foreign substance in air; and
a dust collector configured to collect the charged foreign substance and to remove the charged foreign substance from the air, the dust collector comprising:
a first conductive layer comprising a plurality of pattern electrodes;
a second conductive layer adjacent to the first conductive layer;
memory storing one or more instructions; and
at least one processor,
wherein the one or more instructions, when executed by the at least one processor individually or collectively, cause the dust collector to:
apply, to the first conductive layer, a voltage with a same polarity as a charged foreign substance in air, wherein the voltage is at least one of an alternating current (AC) voltage or a pulse width modulation (PWM) voltage,
based on the voltage being the AC voltage, apply to the second conductive layer a voltage used when collecting the charged foreign substance or a reference AC voltage, and
based on the voltage being the PWM voltage, apply to the second conductive layer the voltage used when collecting the charged foreign substance or a reference PWM voltage.

17. The air handler of claim 16, wherein the plurality of pattern electrodes are respective lines spaced at regular intervals.

18. The air handler of claim 16, wherein each of the plurality of pattern electrodes is in a spiral shape or a zigzag shape on the first conductive layer.

19. The air handler of claim 16, wherein an interval between the plurality of pattern electrodes is less than or equal to a distance between the first conductive layer and the second conductive layer.

20. The air handler of claim 16, wherein a strength of an electric field formed between the plurality of pattern electrodes is 3 kV/mm or less.
